(19) United States
(12) Patent Application Publication
(10) Pub. No.: US 2015/0245167 A1
(43) Pub. Date: Aug. 27, 2015

(54) PROXIMITY-RELATED DEVICE DETERMINATIONS

(71) Applicant: Empath Technologies Patent Holdings, LLC, New York, NY (US)

(72) Inventors: Frederick S. Bobrow, New York, NY (US); Daniel Gavula, New York, NY (US); Michael Toomey, New York, NY (US)

(21) Appl. No.: 14/699,351

(22) Filed: Apr. 29, 2015

Related U.S. Application Data
(63) Continuation-in-part of application No. 14/476,282, filed on Sep. 3, 2014.
Application No. 14/476,282 is a continuation of application No. 13/720,460, filed on Dec. 19, 2012.
(60) Provisional application No. 61/577,254, filed on Dec. 19, 2011.
(60) Provisional application No. 61/577,287, filed on Dec. 19, 2011.

(51) Int. Cl. H04W 4/00; H04W 8/00; H04W 4/02

(52) U.S. Cl. CPC H04W 4/008; H04W 4/023; H04W 8/005

(57) ABSTRACT

In general, one aspect of the subject matter described herein can be embodied in methods that include the actions of: for each of a plurality of devices, perceiving, in relation to the device, one or more proximate devices, generating a record of the perception of the one or more proximate devices, receiving, from at least one of the one or more proximate devices, one or more records of respective prior perceptions of one or more devices in relation to the at least one of the one or more proximate devices, and providing, to another device that is not among the one or more proximate devices, (a) the record of the perception of the one or more proximate devices and (b) the one or more records of respective prior perceptions.

### CROSS-REFERENCE TO RELATED APPLICATIONS

This application is a continuation-in-part of U.S. patent application Ser. No. 14/476,282, filed Sep. 3, 2014, Entitled: Proximity-Related Device Determinations, which is a continuation application of U.S. patent application Ser. No. 13/720,460, filed Dec. 19, 2012, Entitled: Proximity-Related Device Determinations; which claims the benefit of U.S. Patent Application Ser. No. 61/577,254, filed Dec. 19, 2011, and U.S. Patent Application Ser. No. 61/577,287, filed Dec. 19, 2011, each of which is hereby incorporated by reference in its respective entirety.

### BACKGROUND

Many devices, such as electronic devices, have the capacity to communicate with one another, however few of such devices are actually configured to so communicate. It is with respect to these and other considerations that the disclosure made herein is presented.

### SUMMARY

This specification describes technologies relating to proximity-related device determination(s).

In general, one aspect of the subject matter described in this specification can be embodied in methods for proximity-related device determination(s). The method includes the actions of: for each of a plurality of devices, perceiving, in relation to the device, one or more proximate devices, generating a record of the perception of the one or more proximate devices, receiving, from at least one of the one or more proximate devices, one or more records of respective prior perceptions of one or more devices in relation to the at least one of the one or more proximate devices, and providing, to another device that is not among the one or more proximate devices, (a) the record of the perception of the one or more proximate devices and (b) the one or more records of respective prior perceptions.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a high-level diagram illustrating an exemplary null session;

FIG. 2 is a high-level diagram illustrating an exemplary start session;

FIG. 3 is a high-level diagram illustrating an exemplary 3 Empath session;

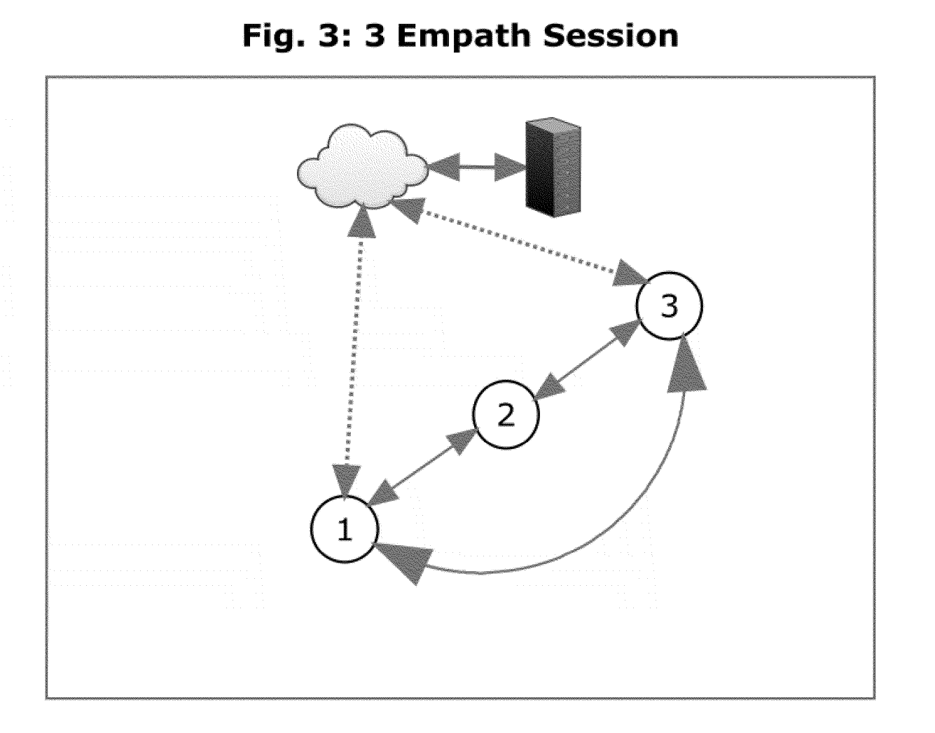

FIG. 4 is a high-level diagram illustrating an exemplary 4 Empath session;

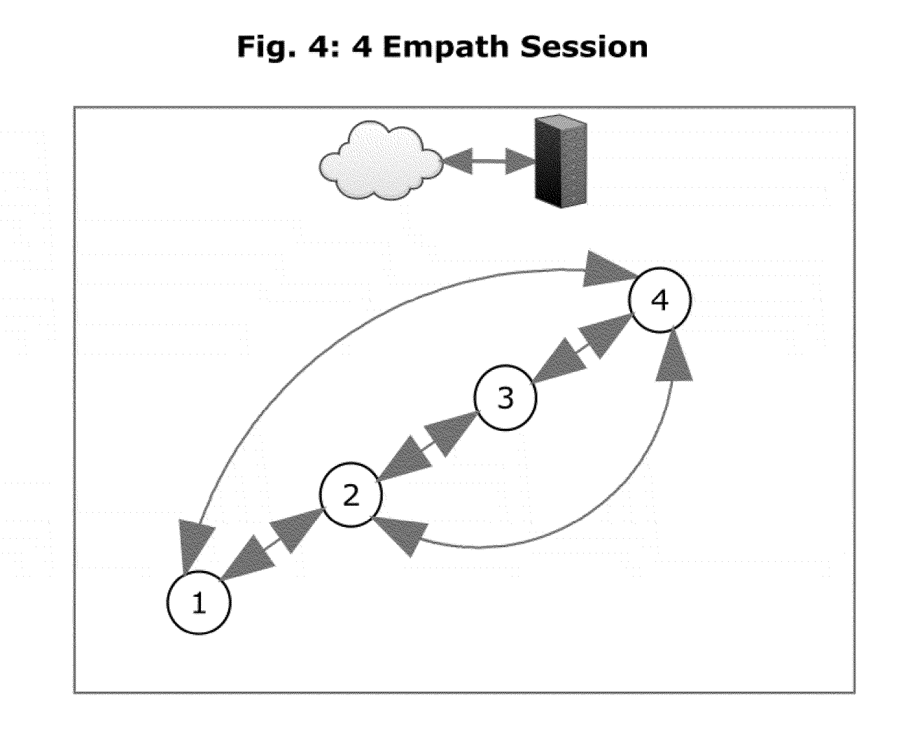

FIG. 5 is a high-level diagram illustrating an exemplary 5 Empath session;

FIG. 6 is a high-level diagram illustrating an exemplary 5 Empath session;

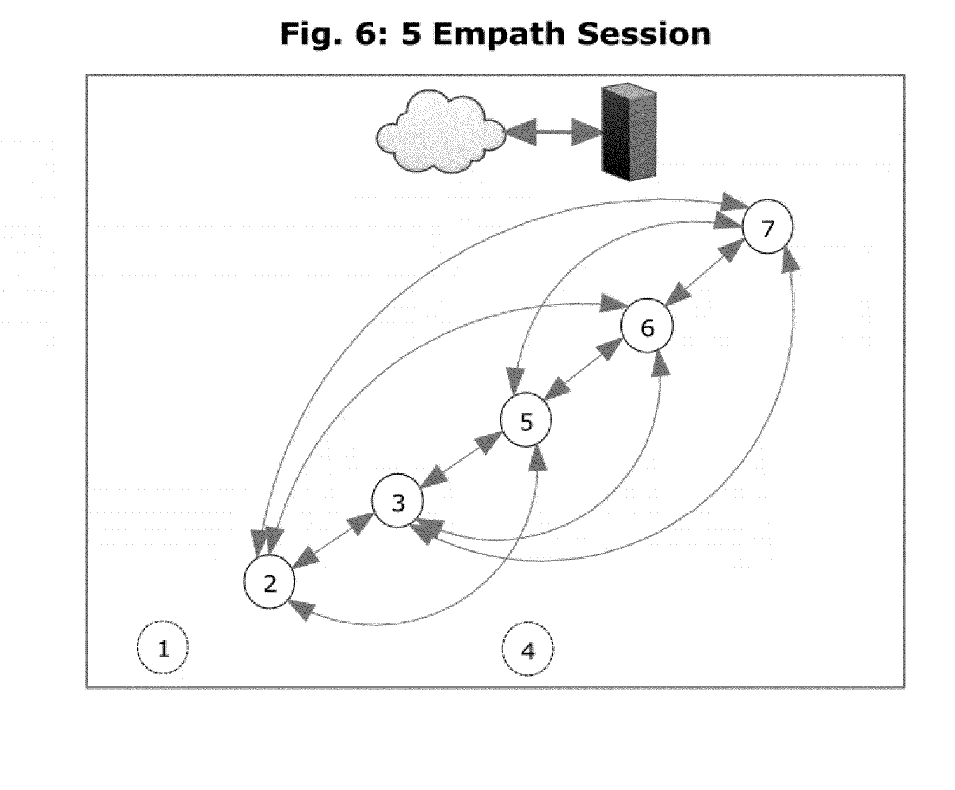

FIG. 7 is a high-level diagram illustrating an exemplary 3 Empath session;

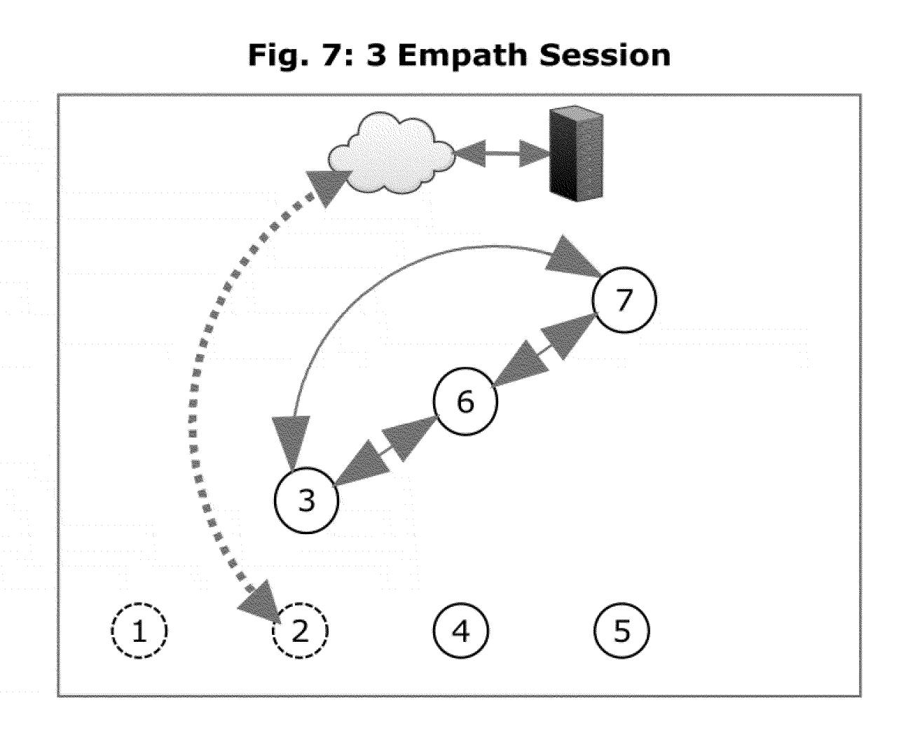

FIG. 8 is a high-level diagram illustrating an exemplary end session;

FIG. 9 is a high-level diagram illustrating exemplary multiple sessions;

FIG. 10 is a high-level diagram illustrating an exemplary adaptive fallback data trasnfer;

FIG. 11 is a high-level diagram illustrating an exemplary multi server control solution;

FIG. 12 is a high-level diagram illustrating an exemplary data reconstitution;

FIG. 13 is a high-level diagram illustrating an exemplary interface screen;

FIG. 14 is a high-level diagram illustrating an exemplary interface screen;

FIG. 15 is a high-level diagram illustrating an exemplary interface screen;

FIG. 16 is a high-level diagram illustrating an exemplary interface screen;

FIG. 17 is a high-level diagram illustrating an exemplary node registration;

FIG. 18 is a high-level diagram illustrating an exemplary seed propagation;

FIG. 19 is a high-level diagram illustrating an exemplary seed passing;

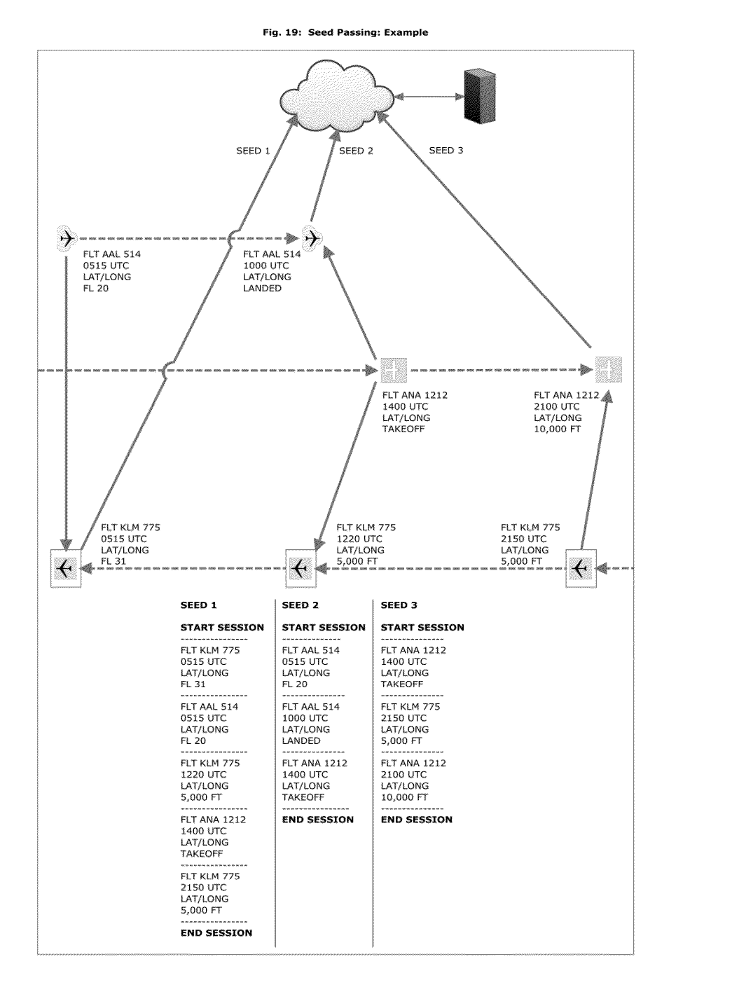

FIG. 20 is a high-level diagram illustrating an exemplary risk reduction;

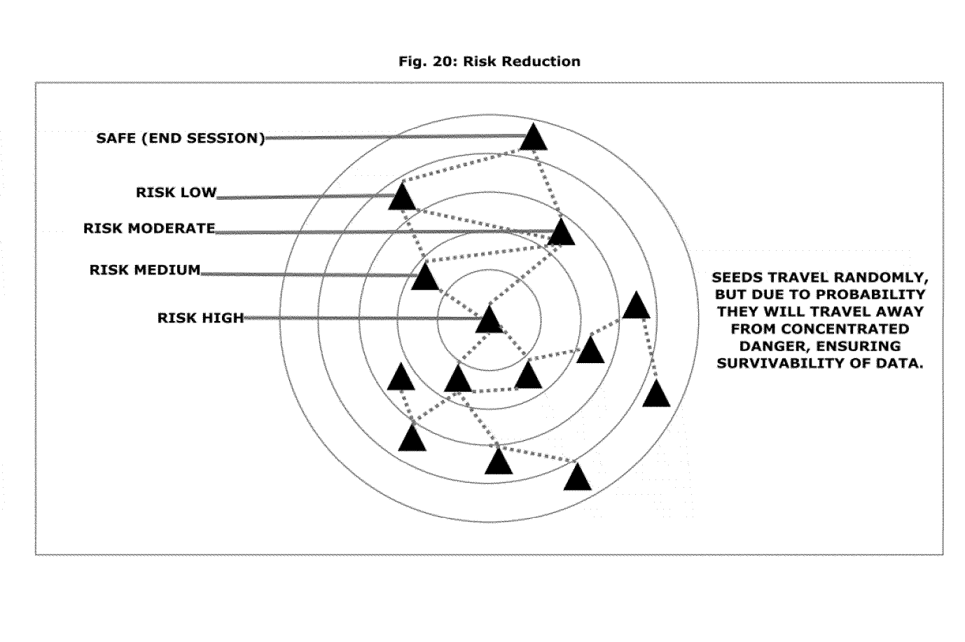

FIG. 21 is a high-level diagram illustrating an exemplary system architecture;

FIG. 22 depicts an exemplary native application architecture;

FIG. 23 depicts an exemplary browser based application architecture;

FIG. 24 depicts an exemplary module dependency view;

FIG. 25 depicts an exemplary high level domain;

FIG. 26 depicts an exemplary data architecture strategy;

FIG. 27 depicts an exemplary wire protocol encoding;

FIG. 28 is a high-level diagram illustrating a further exemplary configuration of a Empath system;

FIG. 29 depicts a flow diagram showing a routine that illustrates a broad aspect of a method for proximity-related device determination(s) in accordance with at least one embodiment disclosed herein;

FIG. 30 depicts a flow diagram showing a routine that illustrates a broad aspect of a method for proximity-related device determination(s) in accordance with at least one embodiment disclosed herein;

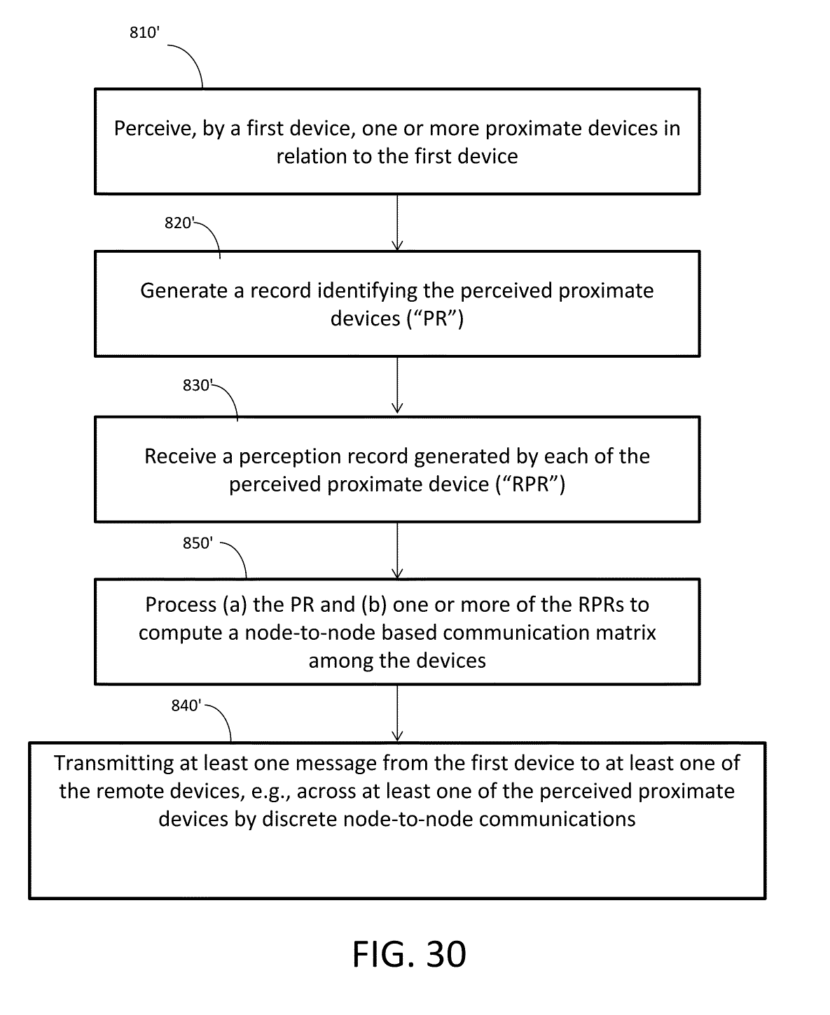

FIG. 31 is a high-level diagram illustrating an exemplary visualization of an empath session; and

FIG. 32 depicts a flow diagram showing a routine that illustrates a broad aspect of a method for proximity-related device determination(s) in accordance with at least one embodiment disclosed herein.

Like reference symbols in the various drawings indicate like elements.

### DETAILED DESCRIPTION

By way of overview and introduction, it can be appreciated that as society grows both people and things enmesh in a way that causes them to invariably and inevitably interact. The social order promotes a matrix of people and things that connect human passersby, animals, vehicles, and/or virtually any “thing” stationary or in motion, or combination thereof. With the ubiquity and near saturation of mobile and fixed computing devices, their 24/7 always on nature and proximity to their hosts, there exists an environment which allows leveraging of data about each object or thing, in relation to one another, and permutations thereof.

Rather than depending on a single “Black Box” data source that may be misplaced or destroyed, described herein in various implementations are systems and methods that provided a nearly limitless number of “virtual black box” data sources that, even when separated, which may support and effectively construct a unified data stream from interrelated but independent reporting sources, revealing a virtual data witness seeking safety and retrieval by shifting distributed information “seeds” away from hazard. Moreover, such technologies provide the ability to exploit previously unavailable interactions between such ubiquitous devices and their constituents in an empathic manner.

Accordingly, described herein are systems and methods for proximity-related device determination(s). The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

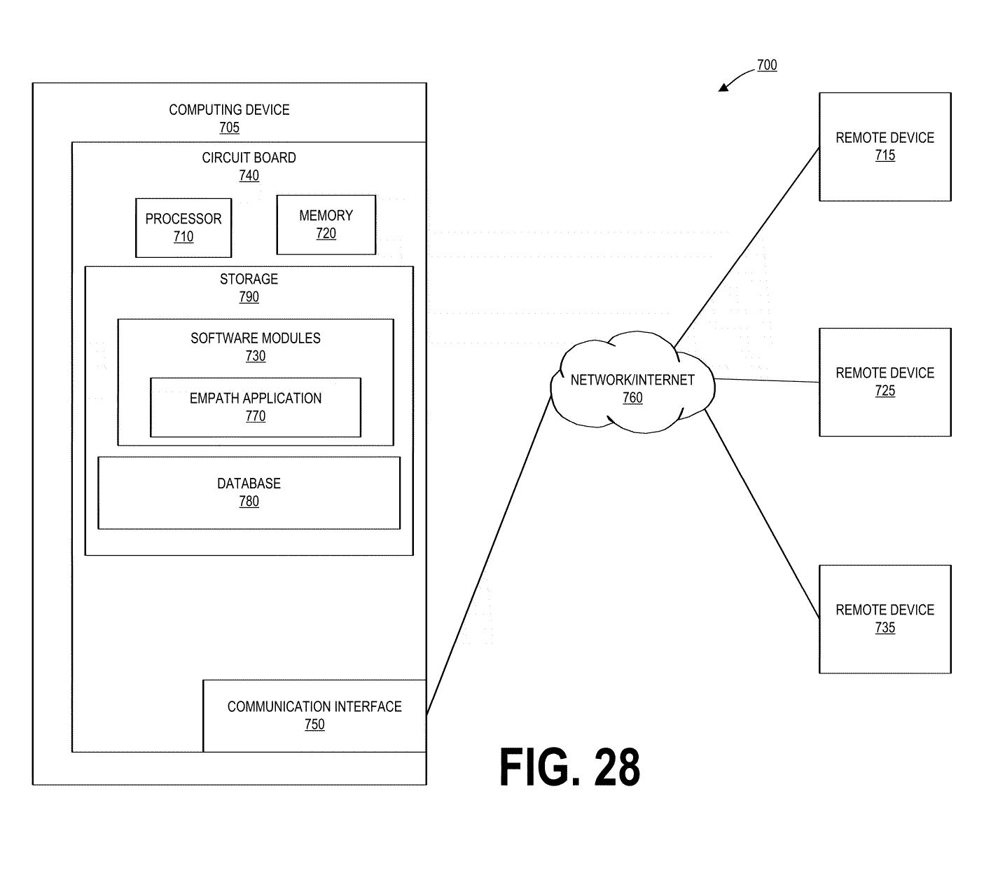

An exemplary computer system is shown as a block diagram in FIG. 28 which is a high-level diagram illustrating an exemplary configuration of a Empath system 700. In one implementation, computing device 705 can be a personal computer or server. In other implementations, computing device 705 can be a tablet computer, a laptop computer, or a mobile device/smartphone, though it should be understood that computing device 705 of Empath system 700 can be practically any computing device and/or data processing apparatus capable of embodying the systems and/or methods described herein.

Computing device 705 of Empath system 700 includes a circuit board 740, such as a motherboard, which is operatively connected to various hardware and software components that serve to enable operation of the Empath system 700. The circuit board 740 is operatively connected to a processor 710 and a memory 720. Processor 710 serves to execute instructions for software that can be loaded into memory 720. Processor 710 can be a number of processors, a multi-processor core, or some other type of processor, depending on the particular implementation. Further, processor 710 can be implemented using a number of heterogeneous processor systems in which a main processor is present with secondary processors on a single chip. As another illustrative example, processor 710 can be a symmetric multi-processor system containing multiple processors of the same type.

Preferably, memory 720 and/or storage 790 are accessible by processor 710, thereby enabling processor 710 to receive and execute instructions stored on memory 720 and/or on storage 790. Memory 720 can be, for example, a random access memory (RAM) or any other suitable volatile or non-volatile computer readable storage medium. In addition, memory 720 can be fixed or removable. Storage 790 can take various forms, depending on the particular implementation. For example, storage 790 can contain one or more components or devices such as a hard drive, a flash memory, a rewritable optical disk, a rewritable magnetic tape, or some combination of the above. Storage 790 also can be fixed or removable.

One or more software modules 730 are encoded in storage 790 and/or in memory 720. The software modules 730 can comprise one or more software programs or applications having computer program code or a set of instructions executed in processor 710. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 705, partly on computing device 705, as a stand-alone software package, partly on computing device 705 and partly on a remote computer/device, or entirely on the remote computer/device or server. In the latter scenario, the remote computer can be connected to computing device 705 through any type of network, including a local area network (LAN) or a wide area network (WAN), or the connection can be made to an external computer (for example, through the Internet 760 using an Internet Service Provider).

One or more software modules 730, including program code/instructions, are located in a functional form on one or more computer readable storage devices (such as memory 720 and/or storage 790) that can be selectively removable. The software modules 730 can be loaded onto or transferred to computing device 705 for execution by processor 710. It can also be said that the program code of software modules 730 and one or more computer readable storage devices (such as memory 720 and/or storage 790) form a computer program product that can be manufactured and/or distributed in accordance with the technologies described herein, as is known to those of ordinary skill in the art.

It should be understood that in some illustrative embodiments, one or more of software modules 730 can be downloaded over a network to storage 790 from another device or system via communication interface 750 for use within Empath system 700. For instance, program code stored in a computer readable storage device in a server can be downloaded over a network from the server to Empath system 700.

Preferably, included among the software modules 730 is an Empath application 770 that is executed by processor 710. During execution of the software modules 730, and specifically the Empath application 770, the processor 710 configures the circuit board 740 to perform various operations relating to proximity-related device determination(s) with computing device 705, as will be described in greater detail below. It should be understood that while software modules 730 and/or Empath application 770 can be embodied in any number of computer executable formats, in certain implementations software modules 730 and/or Empath application 770 comprise one or more applications that are configured to be executed at computing device 705 in conjunction with one or more applications or ‘apps’ executing at remote devices, such as computing device(s) 715, 725, and/or 735 and/or one or more viewers such as internet browsers and/or proprietary applications. Furthermore, in certain implementations, software modules 730 and/or Empath application 770 can be configured to execute at the request or selection of a user of one of computing devices 715, 725, and/or 735 (or any other such user having the ability to execute a program in relation to computing device 705, such as a network administrator), while in other implementations computing device 705 can be configured to automatically execute software modules 730 and/or Empath application 770, without requiring an affirmative request to execute. It should also be noted that while FIG. 28 depicts memory 720 oriented on circuit board 740, in an alternate arrangement, memory 720 can be operatively connected to the circuit board 740. In addition, it should be noted that other information and/or data relevant to the operation of the present systems and methods (such as database 780) can also be stored on storage 790, as will be discussed in greater detail below.

Also preferably stored on storage 790 is database 780. As will be described in greater detail below, database 780 contains and/or maintains various data items and elements that are utilized throughout the various operations of Empath system 700, as will be described in greater detail herein. It should be noted that although database 780 is depicted as being configured locally to computing device 705, in certain implementations database 780 and/or various of the data elements stored therein can be located remotely (such as on a remote device or server—not shown) and connected to computing device 705 through network 760, in a manner known to those of ordinary skill in the art.

As referenced above, it should be noted that in certain implementations, such as the one depicted in FIG. 28, various of the computing devices 715, 725, 735 can be in periodic or ongoing communication with computing device 705 thorough a computer network such as the Internet 760. Though not shown, it should be understood that in certain other implementations, computing devices 715, 725, and/or 735 can be in periodic or ongoing direct communication with computing device 705, such as through communications interface 750, such as during an interactive multiuser session.

Communication interface 750 is also operatively connected to circuit board 740. Communication interface 750 can be any interface that enables communication between the computing device 705 and external devices, machines and/or elements. Preferably, communication interface 750 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 705 to other computing devices and/or communication networks such as private networks and the Internet. Such connections can include a wired connection or a wireless connection (e.g. using the 802.11 standard) though it should be understood that communication interface 750 can be practically any interface that enables communication to/from the circuit board 740.

As noted above, at various points during the operation of Empath system 700, computing device 705 can communicate with one or more computing devices, such as those controlled and/or maintained by one or more individuals and/or entities, such as user devices 715, 725, and/or 735. Such computing devices transmit and/or receive data to/from computing device 705, thereby preferably initiating maintaining, and/or enhancing the operation of the Empath system 700, as will be described in greater detail below. It should be understood that the computing devices 715-135 can be in direct communication with computing device 705, indirect communication with computing device 705, and/or can be communicatively coordinated with computing device 705, as will be described in greater detail below. While such computing devices can be practically any device capable of communication with computing device 705, in certain embodiments various of the computing devices are preferably servers, while other computing devices are preferably user devices (e.g., personal computers, handheld/portable computers, smartphones, etc.), though it should be understood that practically any computing device that is capable of transmitting and/or receiving data to/from computing device 705 can be similarly substituted.

It should be noted that while FIG. 28 depicts Empath system 700 with respect to computing devices 715, 725, and 735, it should be understood that any number of computing devices can interact with the Empath system 700 in the manner described herein. It should be further understood that a substantial number of the operations described herein are initiated by and/or performed in relation to such computing devices. For example, as referenced above, such computing devices can execute applications and/or viewers which request and/or receive data from computing device 705, such as in the manner described in detail herein.

In the description that follows, certain embodiments and/or arrangements are described with reference to acts and symbolic representations of operations that are performed by one or more devices, such as the Empath system 700 of FIG. 28. As such, it will be understood that such acts and operations, which are at times referred to as being computer-executed or computer-implemented, include the manipulation by processor 710 of electrical signals representing data in a structured form. This manipulation transforms the data and/or maintains them at locations in the memory system of the computer (such as memory 720 and/or storage 790), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the Empath system 700. Other components shown in FIG. 28 can be varied from the illustrative examples shown. The different embodiments can be implemented using any hardware device or system capable of running program code. In another illustrative example, Empath system 700 can take the form of a hardware unit that has circuits that are manufactured or configured for a particular use. This type of hardware can perform operations without needing program code to be loaded into a memory from a computer readable storage device to be configured to perform the operations.

For example, computing device 705 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 730 can be omitted because the processes for the different embodiments are implemented in a hardware unit.

In still another illustrative example, computing device 705 can be implemented using a combination of processors found in computers and hardware units. Processor 710 can have a number of hardware units and a number of processors that are configured to execute software modules 730. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 750 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing device 705, computing devices 715, 725, and 735 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art. It should also be noted that, although not all shown in FIG. 28, various additional components can be incorporated within and/or employed in conjunction with computing device 705.

The methods and systems described herein enable the capture and analysis of real-time events, such as those that can be collected and assembled by a remote server to create an “eyewitness account” based on interactions between any number of objects or devices. Additionally, methods and systems described herein can generate an environment in which dynamic interactions can occur without the presence of a relay or connection to a remote server, system or device.

Moreover, the methods and systems described herein can enable such operations even where a connection to a larger, wide area network is unavailable. In doing so, loss of key data keepers does not result in massive data retrieval failure. For example, active telemetry and monitoring of equipment and cargo can offer location awareness by seeding hardware or objects that come into contact/communication with one another—with the ability to act as a “witness” even after destruction, separation or loss.

In certain implementations, various data items can be collected, such as during the course of everyday human interaction(s). In doing so, an irrefutable and/or verifiable “witness record” of each such interaction can be created, based on the status of fixed and/or mobile devices in relation to any number of others, for example. Accordingly, the methods and systems described herein define a “viral” carrier, or node, which can be hosted by a dedicated and/or unrelated service or application, such as that provided to the end user, which can enable various devices to become a ‘witness,’ by collecting sequential and/or non-sequential “seeds” of information about each other device they come in contact and/or interact with. Examples of such data items include, but are not limited to: time, date, location, proximity, telemetry, personal preferences, user habits, etc.

Any electronic device capable of connectivity can be a candidate for this technology. Additionally, passive electronic devices can also contribute to the witness “accounts” that make up the data stream.

In operation, various data ‘seeds’ can be passed from host to host, such as during the course of a defined session. In certain implementations, such transfers can be achieved via remote command, intended to terminate the session lifecycle predetermined size, time, number of contacts, and/or other method(s). Additionally, the host application can enable real time social interactions and/or business transactions, as will be described herein.

The data ‘seeds’ can be encrypted, such as in a multilayer “shell” during acquisition and/or creation. Such seeds can be collected and decrypted via a “multi-node control” polling (retrieval) method, such as via a cloud based repository. Subsequently, such seeds can be assembled and/or reconstituted in order to create a master record of activity (contiguous data stream).

Such data can by decrypted via a rolling code extraction of the multilayered seeds, where each of a multitude of computer servers may provide a sequence of “key-parts” that can be validated to be viable, and which may perform this agreement validation multiple times, representing the subsequent security layers from seed “mantle” to “core.”

Constituent data can be revealed by querying, for example, a remote virtual repository populated with captured seeds which can be serialized and stamped appropriately to provide context. Thereby, a string of unrelated “witnesses” can reconstruct a timeline or sequence of activity based upon movement by seemingly unconnected individuals and/or objects.

The data referenced herein can be stored, for example, in small strings with overlapping redundancy, thereby enabling microburst collection during periods of connectivity.

The assembly of the seeds into data streams can reveal the detail of the session. The resultant stream can be an accurate resource of eyewitness accounts.

Collecting seeds via this decentralized and random method can ensure survival of at least part of a stream, even if some parts cannot be polled due to a calamitous event.

Further applications can provide insight as to whether photographic and/or video graphic media exists to support data (e.g., a number of nodes based installations may have taken photographs during a period of time).

The systems and methods described herein can provide node to node/node to many/“points to points”/sessions based portability. Such systems and methods can also use any host application (e.g. a mobile media player) or function as a TSR enhancement to an operating system. Moreover, the systems and methods can present a repurposable, multifunction enhancement to mobile or fixed computing systems and/or devices.

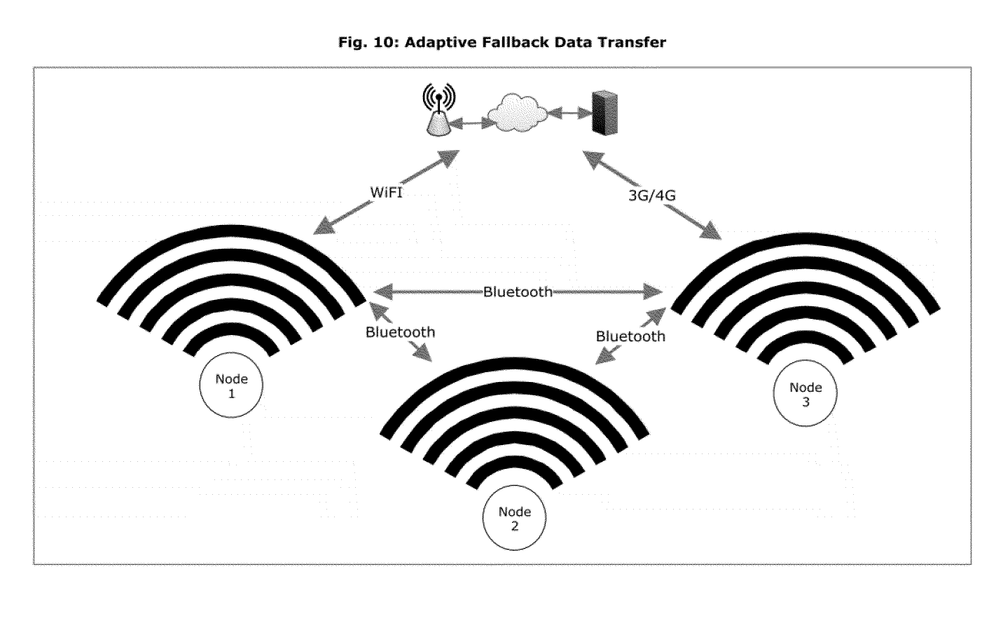

The systems and methods described herein can provide micro, macro and/or global coverage with proximity based auto-adapting transmission fallback does not require continuous connectivity or relay methods (FIG. 10). Moreover, the systems and method can provide remote session assembly and event stream reconstitution of node generated data seeds. Additionally, the systems and methods can provide cloud polling based on “seed” (“constituent data”) retrieval and assembly.

The systems and methods can provide chat based real time and near real time social interaction.

The systems and methods can provide portability anywhere/everywhere persistent service (even while underground or in the absence of wired or wireless network coverage) with assembly and reconstruction of session data upon reestablishing connectivity.

The systems and methods can facilitate a combination of highly targeted human and object based interactions without addressing specific intents and outcomes.

The systems and methods can leverage a host application (e.g. social enabled music experience) as an entrée to a real time interpersonal social interactions.

The systems and methods can provide embedded, integrated e-commerce capability.

The systems and methods can assemble constituent data remotely (and in some cases locally) and allegorical streams can be reconstituted in near real time or left disassembled for archival purposes.

In some implementations, nodes may be treated as independent entities, accumulating, storing and passing serialized naturally recurring and/or user generated data (seeds), identifiers and encryption key components, until polled by algorithm driven delivery, remote command and/or manually initiated retrieval method. However, each device/node may possess the ability to reconstruct data for near real time situational monitoring.

As used herein each mobile node, or “Carrier”, may be referred to as an “Empath.”

A software application containing the host software and seed making catalyst may be installed on a fixed or mobile computing device, which may be referred to as the “Node” or “Empath”, which may contain a CPU, memory, operating system; and a wired or wireless network, Bluetooth or telephonic data adapter. (e.g., the Empath may be the device that contains the software which runs the host application).

The data the Empath may collect, encrypt and/or deliver to the cloud based “Assembler” may be called “Seeds.”

The “Session” may be the act of connecting Empaths in a multi node “Points to Points” fashion.

“Polling,” as referenced herein, can refer to the act of retrieving seeds to a centralized and/or remote location or interconnected remote locations, such as during and/or at the conclusion of a session. Upon retrieval, data seeds may be stored or assembled to provide a full or partially reconstituted event based data stream.

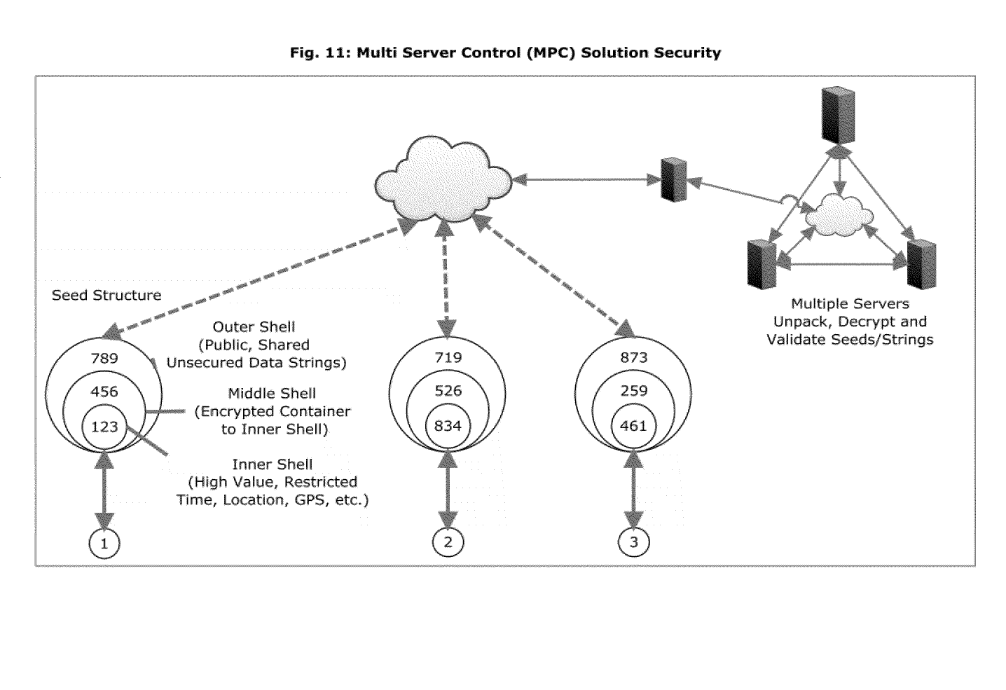

Security can be addressed by means of encapsulating the seeds, carriers or shells, which may build security by nesting encryption keys at deeper levels within the larger structure, which may render each subsequent shell less penetrable without entry access to the more surface shells. The process may be akin to unlocking multiple nested doors, each with different combinations, and the “key-parts” of each combination which may be held by different users. Each “key-part” holder may be given only a partial combination or set of keys. Reassembly may take place only when a coordinated confluence of “key-parts” may be triggered, such as three disparate servers in separate locations making a timed effort at assembling codes and unlocking the shells. This may extend and enhance the concept of “two person control” (TPC) to multi location control. (FIG. 11)

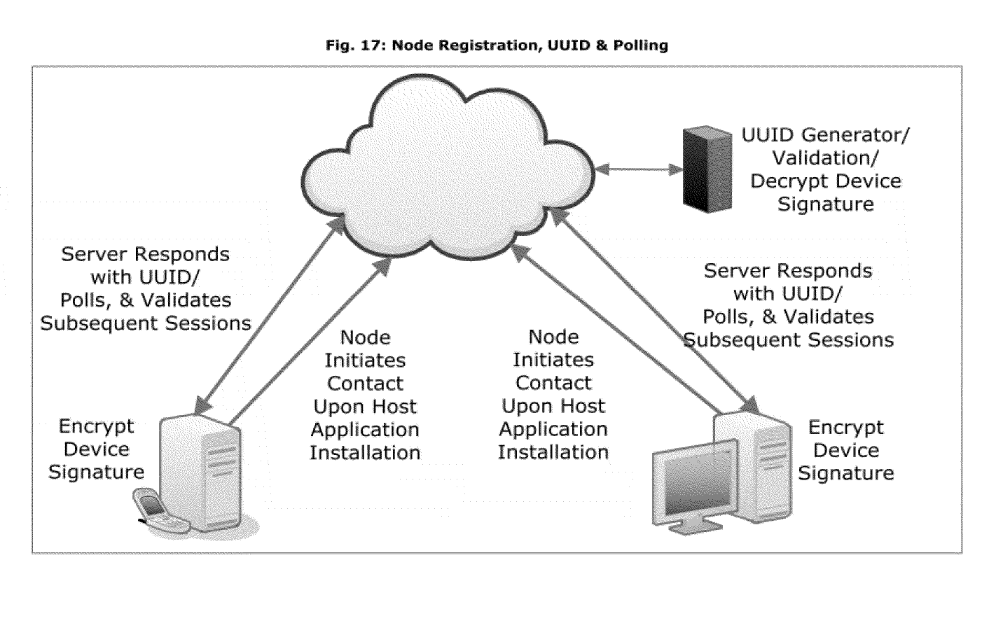

Subsequent to installation of the host application software on the node device, the host may query the device for its digital signature (e.g., SIM ID and/or CPU ID and/or MAC Address), and a message may be sent to the remote server, such as during the first available connectivity window at which time the node may be registered with a UUID which may be returned to the host for subsequent identification, and decipherable only by the remote server. The UUID may be bonded to the node, may be included in each packet retrieved during polling operations, and may be verified each time seed data may be sent (FIG. 17).

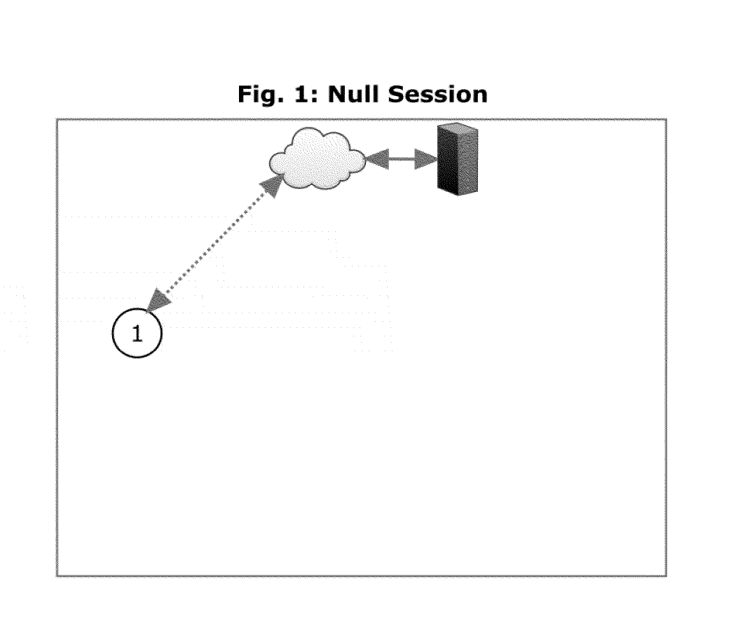

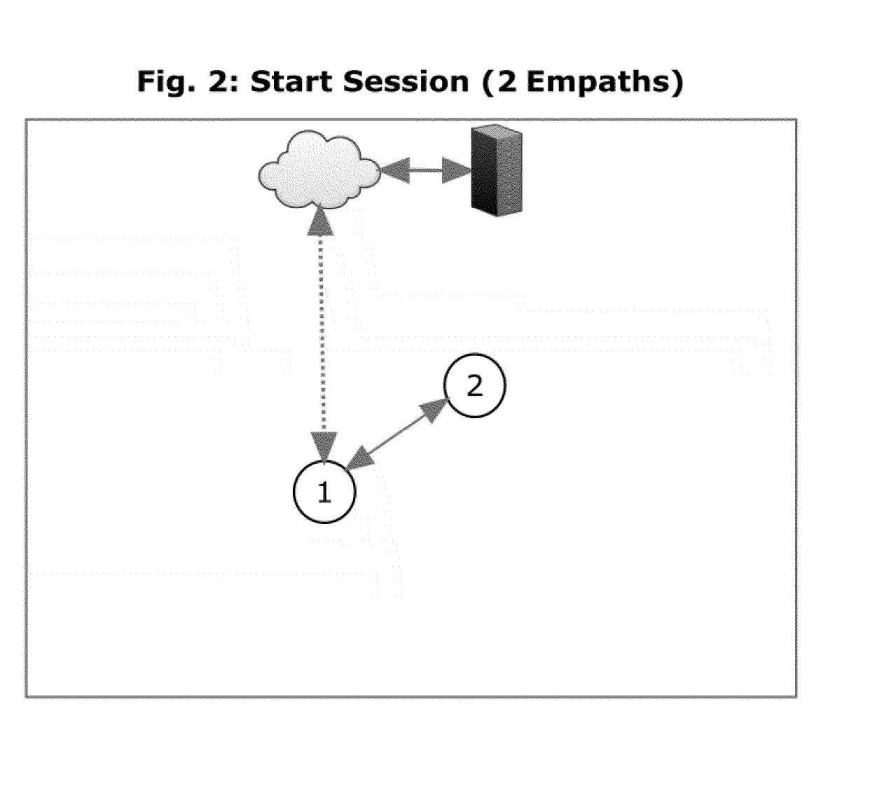

A session can be initiated when two Empaths appear to one another (that is, can perceive one another), such as based on a physical range defined by the user, may preset criteria or external command. (FIG. 2). A session may end when a minimum of two nodes can no longer connect, a timed period expires, and/or an algorithm based termination scheme effects termination. (FIG. 1).

Seeds may be contained in multi-layered encrypted “Shells”; the more sensitive the data, the deeper the seeds may be stored within the shell.

In certain implementations, seeds need not be transmitted to a base, home, relay station, or any other centralized or remote location until a session is complete.

In certain implementations, the seeds can mimic an organic virus, spreading among various passing Empaths, thereby creating data overlap and redundancy. Serialization tags stored in the data string may provide situational perspective during reconstitution.

Seeds may contain, share and pass on any relevant information, including but not limited to: data and/or records about its own or another users state, condition, location, timed or untimed activities, memory contents, user preferences, condition, statistics, GPS data, connection type and speed; the presence of other media such as video and photography, internal navigation or situational awareness device extract output, etc.

Empaths may be capable of extracting defined layers of seed data for use by the host application, as well as adding to seed data at different “depths” based on the type of data that may being captured (FIG. 11).

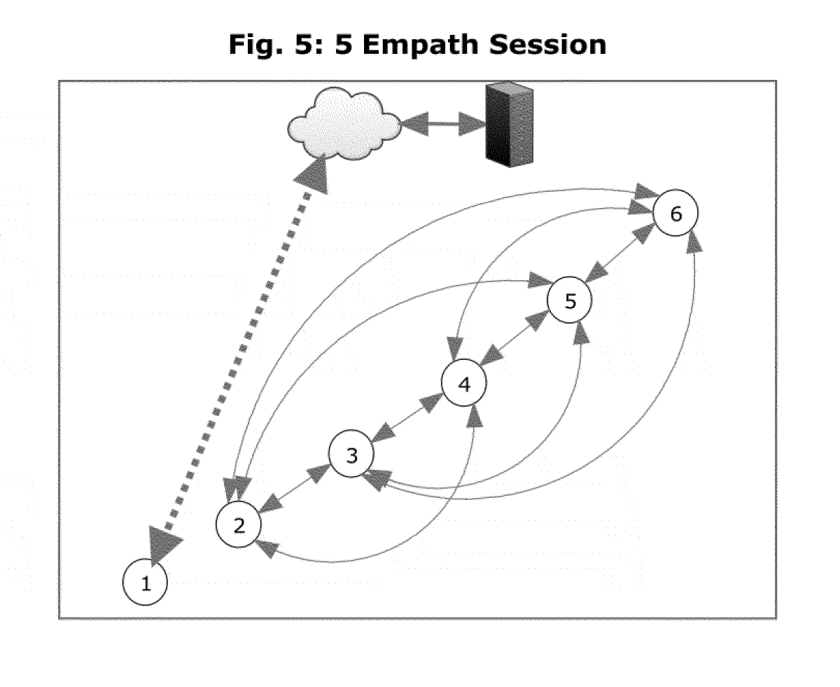

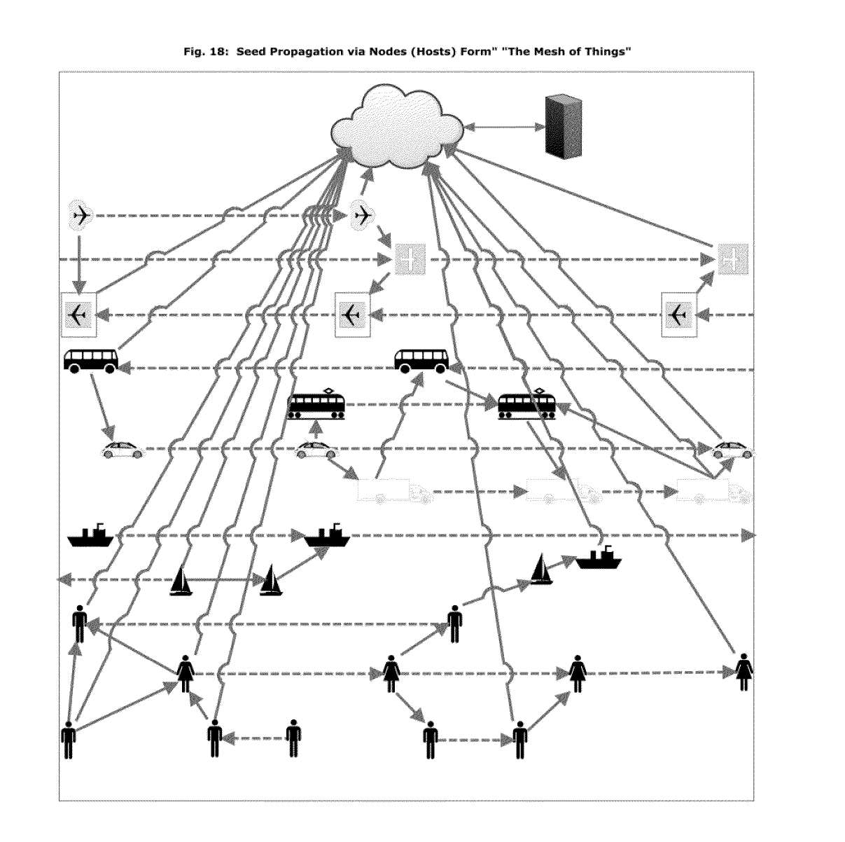

Seeds may save and spread data parts among one another. The seeds may stamp unique serialized strings of identification data about each node and session that may be used to reconstitute “witness reports” during polling. (FIG. 5, FIG. 18)

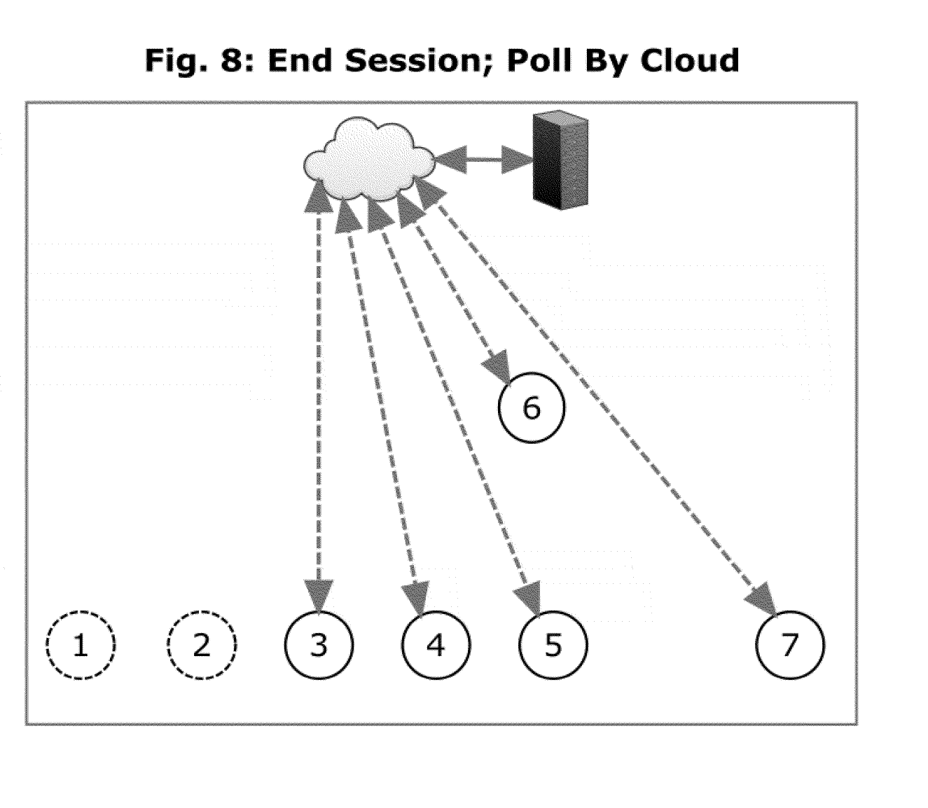

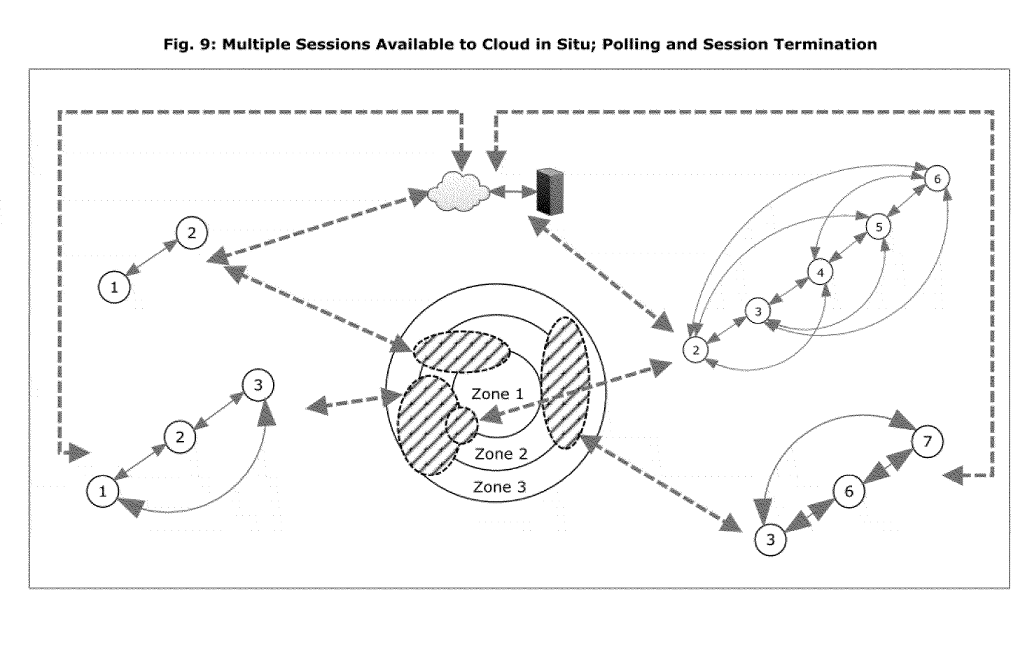

In certain implementations, at the conclusion of each session, Empaths may be polled remotely via a “micro-burst” transmission, when connectivity may be available and desired, and may be delivered to a remote server array. The Assembly Servers may continue to poll or surrender acquisition or retrieval after a period of time, depending on what may be preferred. (FIG. 8, FIG. 9).

Collected data may be assembled using the serialized contents of each seed.

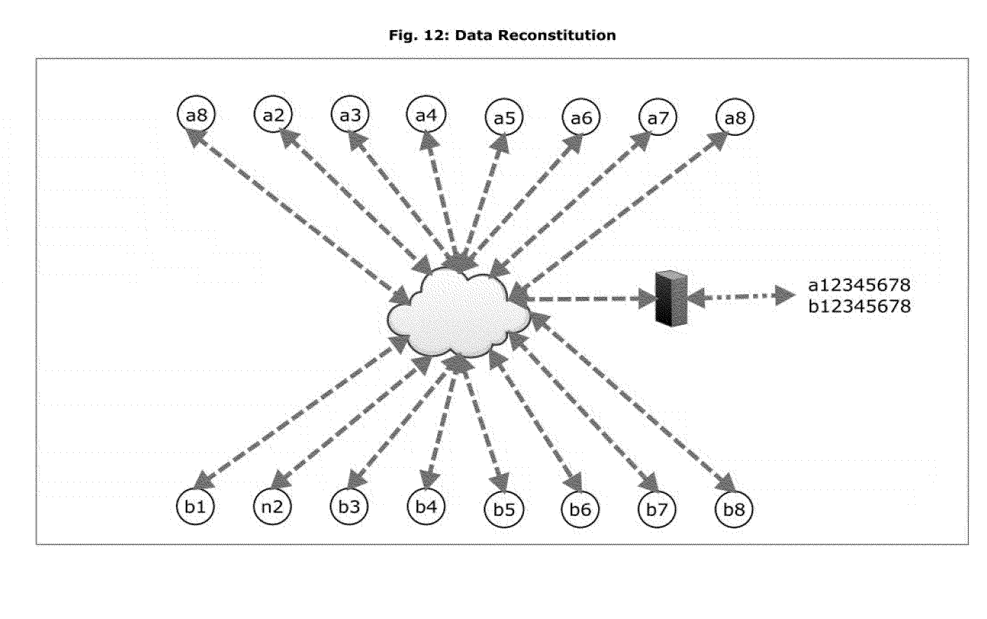

In certain implementations, not all seeds are necessary for assembly or reconstitution. A variable level of completeness which may be based on the number of seeds available subsequent to a session conclusion may feed a metric analyzer to measure the comprehensiveness of the reassembled data stream. (FIG. 12).

The various communications referenced herein can be proximity based utilizing auto-adapting transmission fallback, such as those that do not require continuous connectivity or relay techniques. Transmission may be negotiated based on best available connectivity including but not limited to: wired; Bluetooth; WiFi; Fiber; 3G; 4G; FM; AM; UHF; VLF; etc. (FIG. 10).

This technology may offer random and/or algorithm based passing of multi-layer encrypted, serialized, packetized data among wireless devices (nodes), such as until an uplink may be established or while detection avoidance may be in effect—as in situations where high power or long range communications may be undesirable. Critical detection and reducing dependency on centralized reception or capture via persistent connectivity may be achieved by planting numerous “seeds” that, even after separation or loss may be reconstituted to “tell the story”.

The serialized data may be assembled using an error correction scheme that may fill in gaps based on pre and post prediction algorithms (similar in nature to MPEG video pre/post predictive I/P/B frames but applied to raw data strings). Other schema may include “pre and post” rolling data collection by as much as 50% to cover potential gaps, checkerboard redundant seeds handovers, or have nodes capture randomized redundant data streams. Alternatively, the system may include and define gaps and make those part of the “known to this point” timeline, as gaps may also represent events in by virtue of their (lack of) existence.

The transmissions may be performed via “micro-bursts” to further avoid detection and conserve power—during polling of nearby nodes for the next hand off or hop. That poll and subsequent hop may be extended outward in radius, based on an analysis of spatial proximity between the nodes, to decrease the possibility of a centralized geographically located failure.

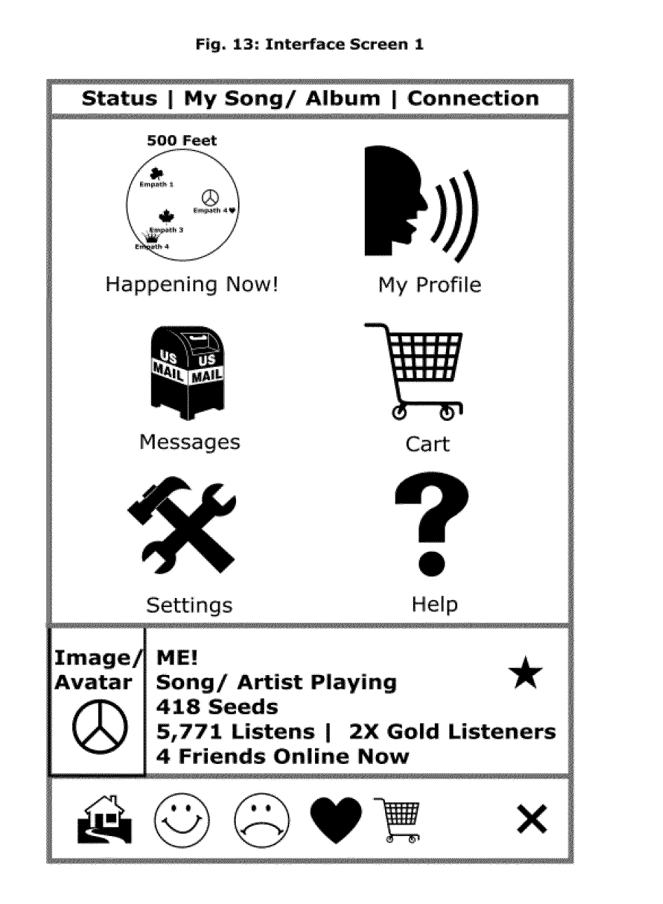

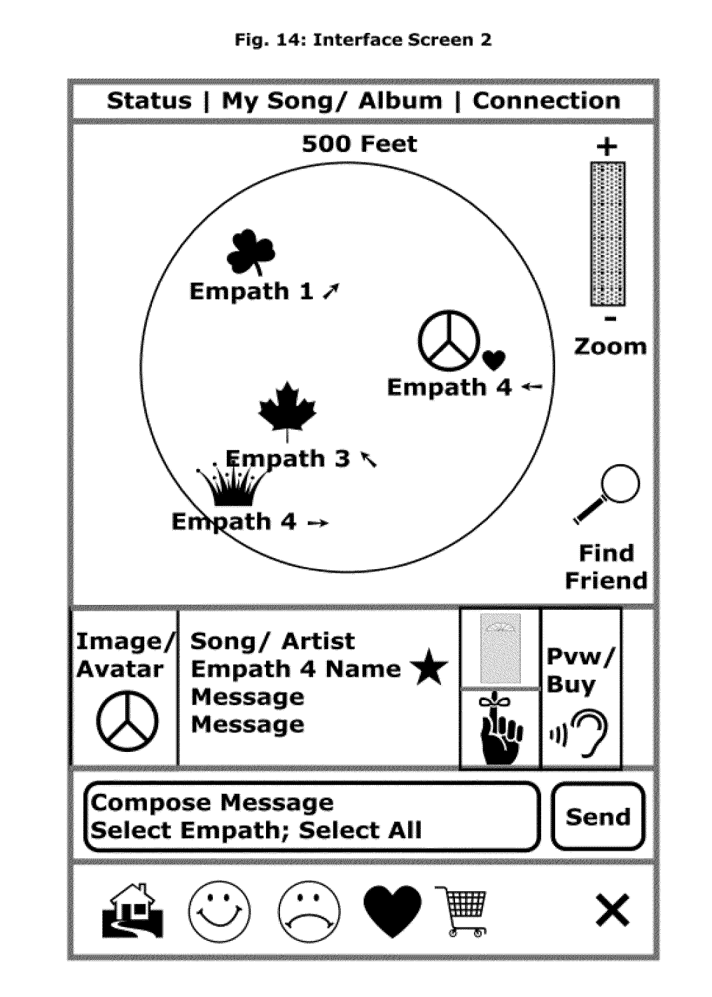

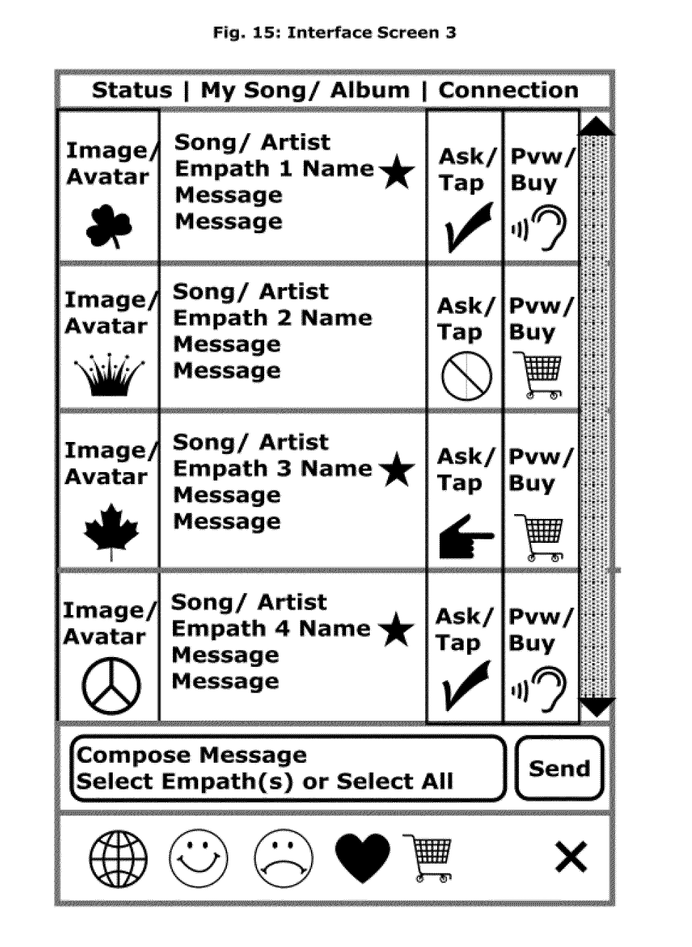

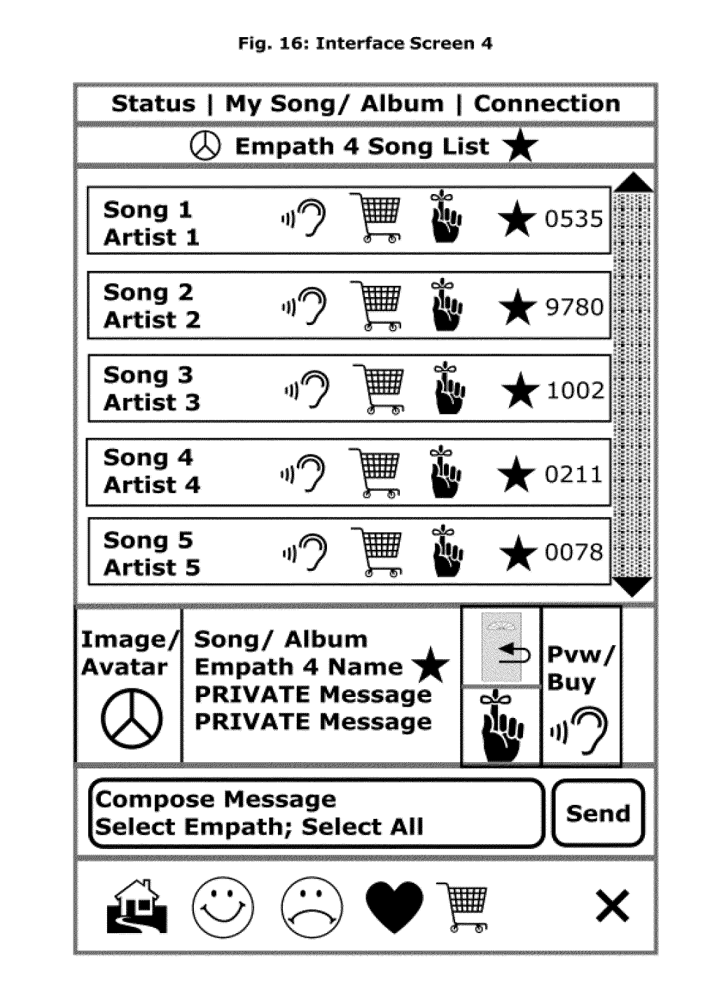

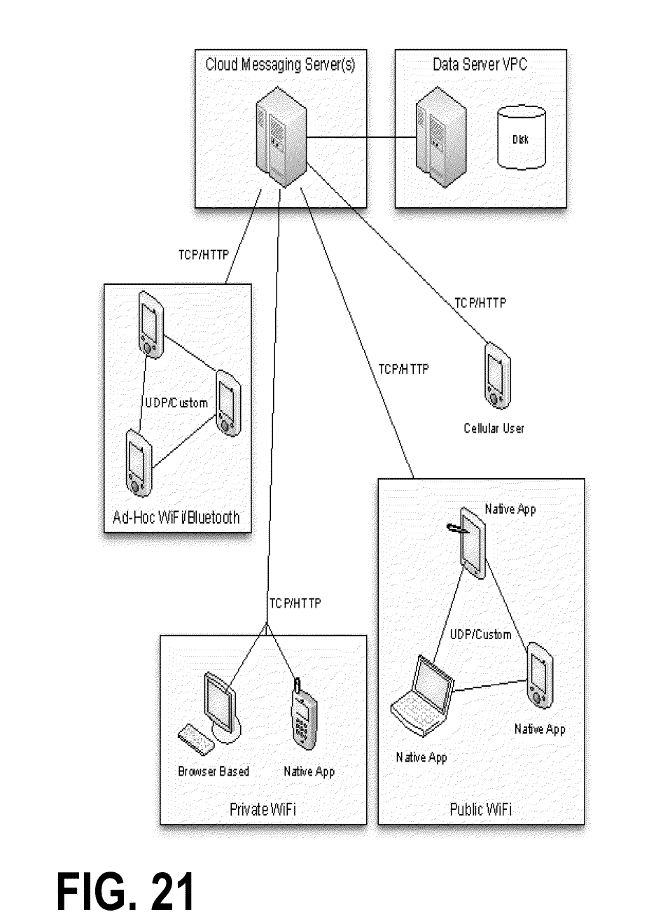

Data may be captured in any form including text, audio, video or telemetry streams (navigational, medical telemetry, situational awareness, etc.). Use cases may include blue tooth connectivity between users to avoid a transmission signature while limiting catastrophic loss of data due to a cataclysmic event in addition to: Criminal Investigation/Law Enforcement (FIG. 21), Aviation, Transportation Logistics, Traffic Control and Civil Engineering, Media and Entertainment (FIGS. 13, 14), Social Networking (FIGS. 15-16), Underground and Mining Operations, Intra-building Operations, Public Safety, E-commerce and Marketing, Accident Reconstruction, and/or Wildlife Control.

By way of further illustration, it can be appreciated that eyewitness identifications of events such as crimes are often unreliable due to a number of factors, which may include but are not limited to memory, confidence, interference and mental state, stress, and/or overload. In the case of witness technology, an eyewitness record free of such human factors may offer the benefit of locating a person of interest, placing them at a scene and creating a visual map of their interactions and, travels and whereabouts.

In one example, the systems and methods described herein may allow exploitation of multiple anonymous devices, to communicate with ubiquitous other anonymous devices to recreate an accurate scene which may be based on seemingly random interactions. When a criminal commits a crime at a specific location, chances may be high that they may eventually come into contact with, or pass another individual, at some point prior, during or after the event. With the Empath application installed either surreptitiously (by a law enforcement official), or willingly (while embedded in an innocuous host application or in ROM) on a suspect device, every other device that comes in casual contact with the Empath of interest may generate a record of that interaction. Even if the suspect's device may be turned off, the other Empaths in the vicinity may capture, record, store, and ultimately report that evidence of the interaction as “silent witnesses”. If and when the suspect's device may be re-enabled, that data (seed) may be retrieved. Witness functions as a real life “game of telephone.”

For example, an assault may be committed in an apartment complex or hotel where perhaps dozens of personal computers and mobile devices may be present. The investigator may search the Empath database for any activity that may have been recorded at the particular time and location of the assault, which may generate a list of persons of interest based on the interaction between the Empaths. Further, if a particular Empath may be detected as moving outward from the scene, that activity may flag that Empath as a potential suspect. That Empath may be positively identified and further tracked via its SIM ID, digital device signature, or in the case of a “disposable” device”, tracked by location. The device may not have to be “in use” or transmitting telephony or messaging data. Data obtained from Empaths may include but may be not limited to: time, GPS location, certain phone data such as call or text logs, etc. The data may seek a way “home” upon reestablishment of connectivity, and may originate from any computing or mobile device, wired or wirelessly.

When a fan was assaulted at Dodger stadium, it may be an almost certain that the victim, perpetrators, as well as thousands of other fans had cellular devices. If a small fraction of those “ordinary citizen” fans, and each convicted felon (having had Empath invisibly installed on their mobile device as a virtual ankle bracelet that they would be unaware of—keeping it close by at all times) had Empath present on their devices, there may have been near instant insight as to who came into contact with the victim and their subsequent movements.

Additionally, other data may be collected from the device, including whether a photo was taken at a specific location at a given time (using common EXIF metadata), allowing investigators to poll Empaths in order to piece together an actual photographic record of an event.

In another example, a similar process may be used to locate a missing person in possession of any type of mobile, cellular or fixed computing device. For example, a person goes missing and abduction may be suspected. Upon contact with an abductor, a seed may be passed and the tracking session begins. Even if the victim's phone may be disabled, the abductor unwittingly and automatically may pass definitive data to other completely unrelated Empaths, whether in a passing car, while stopped at a traffic light, on foot with a passerby, or while at any number of fixed locations. The connection between victim and criminal may be the original interaction that continues to build a record. By querying the Witness database, the last known contact between the victim and the suspect may begin an account culminating in a visual map and awareness of the location and time related to all individuals involved during the incident.

Even if the suspect switches their device on and off to avoid detection, the Empath may seek to deliver its payload in the form of a micro data transmission embedded in whatever signal or connection may be available, when available. Rather than relying on potentially faulty eyewitness accounts and the hope that an artists rendering would lead to an arrest via public outreach, the simple fact that an investigator may instantly piece together the participants at a crime scene and their movements may lead to faster apprehension and more certain prosecution. Removing the human element during reporting of a crime, Witness technology may allow each Empath to become an anonymous and reliable eyewitness to any event.

In certain implementations, the referenced technology may allow passing of encrypted, serialized, packetized data among ubiquitous commercially available wireless devices until an uplink may be established or while detection avoidance may be in effect—as in situations where high power or long range communications may be undesirable. Deprecating detection and reducing dependency on centralized data capture may be achieved by planting numerous “seeds”, may be reconstituted after separation or loss to “tell the story”. Diffusion of data among multiple isolated “viral carriers” and in a pattern outward from the central point of interest may ensure survivability of the narrative record.

The transmissions may be performed in micro-bursts to further avoid detection and conserve power—during polling of nearby nodes for the next hand off or hop. That poll and subsequent hop may be extended outward in radius, based on an analysis of spatial proximity between the nodes, to decrease the possibility of a centralized geographically located failure.

Data may be captured in any form including but not limited to text, audio, video or telemetry streams (navigational, medical, situational awareness, etc.). Transmission methods may include ordinary and signal adaptive blue tooth, WiFi, wireless telephony, and wired connectivity between agents avoiding a transmission signature while also limiting catastrophic loss of data due to a cataclysmic event; while underground operations, or during intra-building operations—where signal may be unavailable and loss of key data keepers may not result in massive data retrieval failure; active telemetry and monitoring may offer location awareness by seeding hardware or objects that comes in close contact with one another—with the ability to act as a “witness” even after destruction, separation or loss.

Data may be passed in miniscule packets or “seeds” multiplexed into the hash occurring during other ordinary transmissions such as a text message, email or web session. Further, the data may be encrypted in such a manner that if it were to be discovered it would resemble nothing more than junk code. Retrieval may be may be performed remotely and may not require an active push by the sender—although that may be may be an option.

In another example seeds may be planted in “low significance” common objects that contain native WiFi or Bluetooth capability such as computer printers, copy machines, digital cameras, WiFi memory storage devices, etc. Such ubiquitous mass produced devices may do little to raise the suspicion of a bad actor, and their real value may lie in the fact that they remain dormant until the presence of a Witness host device, at which time they may “stamp the passport” or generate/pass the “seed” indicating that contact between the object and the host has taken place, thereby placing the person and the object at the same place and time.

In certain implementations, a presence of a piece of hardware at a particular location can be indicated, and further may indicate that such device found its way to a location although it may not have been authorized to. Additionally, multiple devices may have the ability to communicate with one another, indicating a pattern of acquisition, employment and location of such devices by an actor or government. Such knowledge may indicate the existence of a type of facility, point to how such technology was acquired, possibly, and indicated which technologies may be being used in combination creating further possibilities of matrixing the trail.

Multilayered distributed key “guardian” technology may ensure that messages may be unreadable, unrecognizable and useless without the combination encryption offered by Witness. Additionally, as transmissions may be both minute in size and random in nature, they may blend in with the normal chatter and noise found in the ordinary EM spectrum or piggy back onto other transmissions or EM bursts.

This highly downstream vision viewed from a virtual “umbrella” may be available to decipher as humans are inclined to be creatures of habit and tend not to vary their patterns. It may be the abnormal or the unusual that the Witness algorithm may be continuously probing, and ultimately promoting, for further examination and inspection and potential action/mitigation.

Currently aircrafts rely on ground-based radar and black boxes to maintain a record of its location and/or telemetry data. Should an aircraft lose contact with a ground based station through a simple transponder failure or a catastrophic event, awareness of its location may be lost until relocated by radio contact, an ELT (Emergency Locator Transmitter), etc. If the ELT becomes inoperative for any reason, a visual search may have to be commenced. Additionally, the black box may be damaged beyond repair or missing, further hampering the ability to reconstruct the terminal portion of the flight. This technology may allow “casual parties” (Empaths) to generate a redundant data record (seed) of every flight from start to finish by generating seed-based data records on every flight, and every other flight that comes in contact with it, establishing a timeline-based record that may contain simple to complex data (time, GPS, acceleration, spatial orientation, etc). The system may benefit from any type of computing system within the vicinity, from passenger cell phones on the ground, to passenger WiFi connected devices in the air, and telemetry generating equipment on the aircraft if desired. The data can originate from diffuse points (other aircraft, passengers on other flights, etc.), such as the Empaths. Additionally, data may be collected in real time for diffuse, physically separated sources (Empaths), so data is not placed at risk by the necessity of a transmission originating from a single source (the aircraft).

From the time an aircraft is on the ground in maintenance or at the gate, and through every phase of flight, “virtual sightings” may be automatically generated and recorded by Empaths on passing persons, vehicles and aircraft, as well as originate from perhaps dozens of points onboard the aircraft itself, creating a matrix by which disposition the disposition of the aircraft may be traced and recorded using tools such as portable computing devices and pervasive technologies such as WiFi and 3G. As the system may be hardware and software agnostic, no additional infrastructure may be necessary, and by sheer volume and indisputable reliability of these “watchers” offer an eyewitness perspective during search and identification operations.

A medium range jet aircraft departs from an airport where perhaps fourteen hundred flight operations occur daily, and hundreds of users may be on their mobile devices at any given time. A number of passengers onboard the aircraft may have the Empath software installed in either ROM or as an application on their device. Data “sessions” may begin immediately as the passengers leave the terminal, walk down the jetway and take their seats. Aircrafts at adjacent gates may also be carrying Empaths, and more seed data may be generated and session data may be passed. These interactions/sessions may continue until passenger devices may be switched off for takeoff, and resume once in the sky, where they may utilize WiFi. Empaths on passing aircrafts (often separated by only 1,000 or 2,000 feet vertically depending on altitude) may create an additive record culminating in a mapable matrix of traceable activity. Should the aircraft (or aircrafts) lose radio or radar communication, the last known whereabouts of the aircraft may be stored and reported as “seeds” by those diffuse Empaths that may have been last in contact with the missing plane, and may be used to plot and/or reconstruct its course.

Additionally, smaller general aviation aircrafts may not carry black boxes or flight recorders, and in some cases may not have access to or utilize Air Traffic Control (ATC) (or file flight plans with the Federal Aviation Administration (FAA) when traveling Visual Flight Rules (VFR)). However, a prevalence of these pilots may utilize mobile computing devices such as tablets, PDAs and cellular phones. With nearly 229,000 active general aviation (non-commercial) aircraft comprising over 28M tower operations at 5,200 airports (US only), the opportunity exists to leverage existing resources to enhance safety, security and improve coexistence with commercial aircraft.

A general aviation aircraft may fly VFR and become missing during some point during the course of its travels. The aircraft may have landed and fueled at three airports, only one having a tower. During flight, taxiing, and ground operations, the aircraft may have passed numerous other Empaths, including those in vehicles, on persons, etc. That aircraft may now be tracked by these interactions by querying the Witness database. Additionally, situational awareness information may also be obtained if any device that came into contact with the target was so provisioned and capable, thereby creating a virtual flight data recorder, and offering more insight into the location and disposition of the aircraft without the need for external hardware or special communications or transmission devices.

Further, Witness may operate downstream of radar, GPS and radio transmission, thereby increasing availability and reliability. The more an object travels, the more data interactions it may generate, and the easier it may be to retrieve.

Many goods are transported by road, rail or ship prior to reaching their final destination, which may be by an inconsistent and unregulated patchwork network of vehicles, expediters and transport methods. Other than having a costly and complex network of potentially obsolete hardware based tracking devices and transmitters, Witness technology may be leveraged to create a time and location based matrix of not only vehicles (including but not limited to trucks, cars, bicycles, boats, and pedestrian personnel), but also the containers and other origination transport means that carry them.

In one example, over the road (OTR) trucks may move massive amounts of goods across country. However, there may be a significant cost involved with dedicating tracking devices to vehicles, maintaining the infrastructure, and providing the human monitoring necessary to manage the sheer volume of vehicles, such complexity and cost may only provide the ability to observe a fraction of the vehicles in motion at any given time. Additionally, such data may be collected in a relative vacuum, without any insight into the activities of other relevant or somewhat related vehicles.

Offering the ability to expand the current awareness from a global view, down to the microscopic level, targeting local delivery persons without the need for dedicated equipment and unabsorbable cost may offer granular insight for almost any business regardless of size which may improve their efficiencies, enhance security and increase productivity.

For example, a local truck driver may leave the distribution center or depot at 7:00 AM with 42 stops scattered over a 50 mile radius. He may not have a tracking device on his vehicle, and his means of recording deliveries may be paper bills of lading, etc. The primary means of communication with the depot may be via cell phone. Throughout the course of his deliveries the driver may be coming into contact with other unrelated truck drivers, passenger vehicles, law enforcement, foot traffic etc. These contacts may be incidental and require absolutely no effort on the part of the driver to record or manage. However, these contacts may form a web or matrix that represents the drivers day.

As the driver makes his stops, his interaction at the location, though not necessarily with the designated recipient, may be captured. Such interactions may be used to create a narrative of time spent between stops, stops off route, which routes were taken, and whether the driver was at the location at the specified time. Data about the habits of the driver may be collected, as well as data about the truck, and its contents. Such data may be used to assess a driver's ability to follow directions, whether the specified route is practical even if the driver fails to report otherwise, and resolve questions related to the driver interaction with the customer at a scheduled time.

In the absence of, or complementary to, bar code scanning hardware, dedicated GPS, always-on transmission connectivity, etc. patterns may be established, metrics may be evaluated, and actions may be taken to improve processes at minimal expense but with a widely expanded data pool. If a shipment were to go missing, the route may be recreated, from unrelated witnesses, to pinpoint the vehicle at a particular moment in time. Additionally, if such shipment is handed off to a secondary or even tertiary local carrier by bicycle or by foot, that extension may be tracked as well based on the increased web of interactions. Queries may be made to forward, reverse or randomly place such interaction in the session matrices.

In another example, cargo containers represent a significant method for transporting goods throughout the world. Current tracking systems may include passive Radio-frequency identification (RFID) technology which may require multiple dedicated installations of RFID tags, localized relay stations and uplink to a central location or server. Such methods may be somewhat cost effective, but may be limited in that they may only alarm the owner of the container at the time of disappearance, and offer no method for tracking subsequent to loss. An alternative active method may require dedicated and expensive computers which may offer limited situational insight and in the presence of other computers and GPS connectivity. By utilizing Witness technology, cost effective globally accessible mobile devices which may already contain inherently identifiable IDs (such as cell phones) may be utilized to establish and maintain a global tracking and loss reduction system.

A shipping container may be fitted with common cellular devices and Witness host software. Further, cell devices may be included at the pallet level for more granular reporting. Throughout the entire course of travel of the shipping container, a record may be created, without the need for constant connectivity, by creating a record based on interactions with other containers, related personnel, vehicles and unrelated devices.

If the container should go missing, objects or persons with a common mobile device and the Witness application that may have come into contact with the missing container or pallet (during the course of its normal travel, at the time of separation, and beyond), may generate a record of the interaction which may be retrieved and reassembled to create the historical record of that shipment in near real time, or any time subsequent to detection or loss. The container's owner may query the database by entering the UUID of the device associated with the shipment to generate the historical record.

The described system may include devices that may be ubiquitous, small and already fully interoperable with an existing infrastructure, such as devices that may operate up to a week (or more) under their own power; once the object breaks contact with its primaries it may still be traceable—even if the contents may be separated (unlike RFID and relay systems), and a traceable route with time stamp and location awareness can be established. Additionally, should the bad actors that came into contact with the shipment at the time of an incident have Witness on their devices a definitive record of that interaction may be recorded. Finally, if the shipment is multi-modal (air, sea, land), the complete, validated, and multi-sourced interaction history and data record may be captured and available as well.

In order to track private or public vehicles for logistical, security or other purposes a GPS or other radio based tracking device may be attached to the vehicle in motion. Thus, vehicles that may not be provided with such hardware may remain anonymous, until and unless captured by a traffic control device such as traffic cameras, electronic toll pass, etc. Further, there may not be a ubiquitous mechanism for tracking vehicles (and their occupants) in the context of a traffic control and management system. Public transportation systems may provide a mechanism for gross measurement of customer entry and use based on cash and/or electronic entry systems, but exit may remain largely anonymous and untraceable.

In one example, witness technology may be leveraged to analyze an action against traffic patterns based on interactions between vehicles, supported on the fact that occupants may possess a mobile device during the course of their travels.

For example, a driver and two occupants, all with Empath host software on their mobile devices may enter a first vehicle. The session may begin with the awareness that the vehicle is now high occupancy. They may enter the traffic pattern with the intent of traveling within a seven mile radius. A second vehicle with a sole occupant (the driver) with Empath enabled may enter the traffic pattern two miles away and will leave the radius eventually. The two vehicles and four individuals may utilize several of the same thoroughfares during the course of their trips for approximately two miles within the five mile radius.

As Empaths pass or otherwise contact one another on the road, in a parking lot, on an overpass, at traffic control devices, etc., these interactions may be recorded as data seeds which may be passed to one another, creating patterns of roadway usage (which must be manually observed), timing of trips, usage of specific types and locations of roadway ramps, driveways, etc., which may be tracked at the vehicle and occupant level Additionally, Witness may generate an awareness of how efficiently trips may be made based on the number of occupants, generating insight into fuel usage per occupant, etc.

With the addition of further Empaths resulting in more complex sessions, the matrix may become more comprehensive, which may allow traffic engineers to dynamically adjust patterns based on actual usage, and how drivers create detours to adapt to conditions. The confluence of activity which may emerge from seemingly unrelated vehicle and occupant interactions may reveal data from which modeling and analysis may be derived.

This technology may help to identify key areas of usage with regard to infrastructure, generating warnings or alerts at predefined maintenance intervals where heavy use may harm bridges or roadways.

A commercial application of such a system may offer insight for real estate developers and retailers to monitor traffic patterns in the vicinity of, and to and from, their locations, in general and at specific times and days. Such patterns may ultimately yield the ability to target sales or promotions during low traffic times, or even offer the consumer alternate routes and co promotions (with other retailers or providers “on the way”) based on the route and usage data collected.

Patterns of individuals may be exploited for use in commercial or social contexts.

As this technology may not be “active” in the sense that the user has to act in any way other than be a passive host, it may differ from the expectation that individuals will install and adopt, and actually use an app (even if they possessed that level of sophistication). As there may not be hardware required other than the mobile device, additional infrastructure may not be needed.

Devices may not necessarily have to be connected, and may not be connected to the data retrieval service (cloud), during the course of their travels as data seeds may be retrieved at any time subsequent to their session.

In another example, this technology may be used to track and evaluate detailed passenger patterns in public transportation (mass transit) systems. Currently, it may be difficult to ascertain where passengers go once they enter the system, whether above or below ground. Insight may be gained into the entire record of the traveler in the system at a point in time or may be measured against a historical record—who transfers to which train/bus and when, and are they traveling alone or in “packs.”

For example, a rider with Witness technology on their device may enter the system at a particular subway platform where they may initiate a session with several other customers, who may be traveling in different directions. The rider may enter the train car at 7:45 AM where they make contact with several other riders, possibly establishing direction based on time reconciled with train data and length of contact. As contacts may be made and broken throughout the course of the trips, patterns may emerge, such as length of interactions, direction (based on session times), individual and group habits, movement throughout the train itself during the course of the trip, etc.

As passengers disembark, patterns may be revealed about where they go once they exit the train, which exit do they use, do they transfer to another train, do they remain underground and use commercial services or shops? Further, travel patterns may extend outside the system extending to the individual or groups ultimate destination. Do they transfer or another public transportation vehicle such as a bus, park and ride, etc.?

As the user device may be identified with each seed collected, hourly, daily, monthly, yearly, etc. patterns and beyond emerge, indicating the busiest routes based on capacity and individual preference. Why do passengers prefer the East vs. the West exit at a particular stop? Would adjusting a schedule by a few minutes have a significant impact on crowding, and could adjustments be made based on the knowledge that certain individuals or groups (students, workers, etc.) only travel certain times and days during the week?

Personal security and law enforcement efforts may be greatly enhanced with the ability to track and monitor individual and group location awareness, during the course of their travel, utilizing public or private transportation systems and combinations thereof, which traverse virtually all of our lives in modern society.

Entertainment on mobile and computer based electronic devices may largely be considered a personal experience. In an effort to increase socialization while enhancing the quality and quantity of usage statistics, this technology may accomplish both goals while adding tangible value to the user's life and awareness of their environment.

By creating “hive of interested parties,” individuals may consent to disclose some or all of their activities on their device, and participating users may be granted the ability of socializing with a wide array of previously unknown individuals with like interests, common tastes, or out of simple curiosity. Friends may have an awareness of one another. Some attributes that friends may be aware of each other may include location and activity.

In one example, a voyeuristic environment may be created leveraging the entertainment product which may be utilized on the user's device at a given time. Whether an individual may be accessing the Wall Street Journal application, listening to a particular song or artist on their music player, or playing a certain game, that information may be derived from the device's system status and stored periodically in the seed that may be passed throughout the course of the user session.

When other users on a bus or train, or in a cafeteria or coffee house, may be able to identify the presence of others with similar likes or tastes. Such information about a user's personal likes may be entered and stored in a user profile, which may then be used to alert them and others that similarly inclined persons may be nearby. The Empath application may then offer the ability to “tag” a person for later contact, or request an electronic chat that may eventually evolve into a real world encounter. The system may enable gaining insight into the minds of those around us, and may allow the individual to act as their own gatekeeper by sharing as much or as little information as they wish, and whether they may be willing to participate in further, escalated interaction.

Regardless of connectivity type, the user nodes may pass seeds amongst one another, forgoing the necessity for a specific transmission methodology, which may constantly promote and demote based on the available transfer channel at any given time. Furthermore, transmission modes may be of mixed types. In the absence of any connectivity or compete failure, encounters and data may be stored, reconstructed and delivered to the users in a manner in which they can still follow their other encounters.

Geographic location may be micro, to macro, to global, creating a trail and network of similarly inclined individuals or in essence, a virtual community, and introduction to such.

The core of this system may be passive in nature, as a user goes about their normal activity. Should an Empath appear “on their radar”, the stage may then be set for continuation or termination.

For those who may be curious as to what the people travelling to work or school with them on the bus may be doing, this may enable a harmless voyeuristic diversion, as identifying an individual without their explicit permission may not be possible.

The media may act as an arbiter and an entrée to further a chance encounter or coincidental passing into a real world social experience. Empath may act as the facilitator to such socialization, a conversation start whereby the person may be somewhat known as opposed to completely foreign.

A voyeuristic satisfaction, sense of security, and sense of community may be enabled even while engaged in a solitary activity if one feels that they have an awareness of what others around them may be looking at, listening to and experiencing (not unlike seeing the what book or newspaper a person is reading vs. only seeing the back of an iPad).

Metrics about media usage may be gathered and analyzed based on user location, time of day, proximity of users, and quantity of contact request initiations and ongoing interactions have occurred. A predictive model may also be used to target such user sets that exhibit strong connection sand/or frequent repeatable habits.

Empaths may be reporting, leveraging one another, and inexorably passing data laterally and upstream vs. having to solely rely on “unicast” reporting back to the cloud, which assumes that users may be “connected” when actively experiencing content.

Currently, computer dating may generally be a solitary experience whereby a person may enter information about themselves and they may be matched to others via a compatibility algorithm. The individual may then initiate contact via chats or emails while in an isolated state. Utilizing the Witness and Empath technology individuals may have real time notification that someone who may match their desired profile parameters may be in real physical proximity, and whether they may be willing to initiate an encounter at that very moment.

For example, two individuals with the Empath application running a dating variant of the technology may enter the same bar or nightclub. They may each be alerted that the other individual may have matched a specific number of points that may be essential to their dating profile. The two individuals may be offered the opportunity to explore other person's profile in greater depth, begin an instant chat, or tag them for later contact.

Opportunities by people who were in the right place at the right time but did not make a connection may be identified and acted upon. A few moments or a few yards may mean the difference between finding an appropriate match. Witness may be the facilitator to the introduction and may assist the individual in casting the net as wide or narrow as they wish.

The ability to experience a real time “matchmaker” based on proximity and in an “on the fly” manner may allow individuals to become less dependent on chance encounters and better leverage technology.

Chance encounters and lost opportunities may be a frustrating aspect of social interaction. Seeing someone that interests you, like having a momentary encounter on a train platform or while standing in line, can lead to frustrating regret if the individuals failed to connect for one reason or another. Perhaps it may be a business contact made on a flight shared by two strangers who failed to exchange information, or transposed the digits of a phone number.

By leveraging the power of Witness, such encounters may be identified and followed up by utilizing the anonymous data collected about a person's location at a particular time, which may be captured in the Witness database. In the past, people may have submitted a personal ad in the newspaper stating “I spoke to you for a moment while waiting for the #5 train on Wednesday at 6 PM, you were wearing a red hat and a brown jacket, but I didn't get your number. Please call me if you are interested in finding out more about what we discussed.” The odds of the other person in that encounter looking at that ad were highly improbable, yet they persisted. However, the opportunity may be possible and virtually automatic.

For example, two individuals who may have Empath installed on their respective mobile devices may come within a specified distance at a particular location, date and time. By querying the anonymous Witness database, an individual may possibly locate the encounter, based on logistical data and the Witness algorithm, and may act upon it by sending a message to that individual.

Days or even months subsequent to an encounter, an individual may seek out that contact, sending an anonymous request to the other anonymous user, which may be facilitated by Witness. Should the queried individual respond positively to the overture, varying levels of contact may be permitted, including chat, email, phone, etc.

As a security measure, the invitee may ask the requestor for permission to perform further discovery prior to responding. Such information may be part of a profile provided by Empath users. Furthermore, the Witness system itself may be useful in verifying certain user provided information, based on scoring a comparison between the users reported data and verified data in the Witness database. (i.e., If a requestor states they work or live in a particular area, that information may be compared to the compiled database information and a “reality score” may be created).

This technology may offer the opportunity of turning a chance encounter into an ongoing conversation or even a relationship. Additionally, it may offer the opportunity to assess the truthfulness of certain statements.

A major risk and shortcoming of any underground, mining or intra-building operation may be lack of communication due to poor signal reception and diminished transmission capabilities. Witness may offer the underground operator the ability to create a narrative of when and where personnel and equipment were last known to be, and may anticipate their present and future location. By passing the seed between man and machine with the intent of moving it away from danger and outward toward collection, user identity, time and location may be passed along from node to node without the need for specialized radio frequency devices or ad hoc networks.

For example, a miner or underground technician may be lowered 100 feet below ground where signal may be unavailable. Throughout the course of their travels they may come into contact with various pieces stationary and moving hardware as well as personnel, each of which may generate a time and spatial depiction of where and when contacts were made, without any effort or intervention by the user.

A session may be considered started as soon as a worker steps onto a descending elevator, and ended as soon as they safely step off an ascending elevator.

As individuals may pass one another, their contacts may be recorded in the data “seeds” which continually spread to form an activity representation. For example, if it is known that person “A” was in location “B” at 1000 hours, and contact was again made in location “C” at 1200 hours, the last known contact may be determined and a map may be created predicting movements over time and last known verified location—in addition to eliminating false positive data.

Additionally, a variant of the Empath application may also record additional data provided by the sensors that already exist in ubiquitous devices, such as accelerometer, gyroscope, temperature, etc. Such information may further serve to create a detailed picture of the last moments prior to contact being broken or a suspected incident has taken place. (i.e., recording and reporting how fast an underground vehicle was traveling as it passes one or a number of objects, and whether that target was level, inverted or tumbling (which might indicate an out of control, situation, fall, distress, or other anomaly)).

The stationary objects such as vehicles, lights, generators, etc. fitted with off the shelf mobile devices and steady power may collect the data being propagated and may continuously pass it up stream (in a virtual data bucket brigade) for near real time monitoring, examination and action. Such devices may be configured to record and report multimedia information such a photographs, video and audio at regular or controller initiated intervals, and pass that stamped data upstream via a dynamically scalable network matrix that may be deployed on the fly and ever changing based on need and circumstances, such as when one tunnel may be closed an another opened. The nature of the network may be that it may constantly extend itself organically with the movements of the users while providing multiple layers of redundancy.

Should a worker require assistance, they may use the Empath application to relay a help request with nothing more that the mobile device they carry for ordinary everyday use. The application may monitor their heart rate, certain environmental conditions, and even send a photo, video and/or audio without the need for high bit rate or terrestrial connectivity, special repeaters, or cellular signal to a central location.

Given the nature of current mobile devices and the micro burst approach to data transmission, contact may be potentially maintained for hundreds of hours.

Witness may be a silent and transparent replacement to the traditional key or swipe check in points that maintenance and security personnel currently employ. Currently a card may be swiped or key turned to indicate that an employee has checked into a specific area. Utilizing Empath the employee may have to be in the vicinity of a node to check in.

As a further security measure, a biometric element may be included in this variant of the Empath application to verify that the right person is checking in, by means included but not limited to: facial recognition, fingerprint, code or any combination thereof. An additional measure of safety may include active audio/video monitoring pre, in situ or post appointment. As with all variants of this technology, the employee or user would have the ability to engage a distress signal should a problem arise.

GPS, cellular signal and specialized equipment may be unnecessary for successful deployment. Two way communications may be facilitated by VoIP packet transmission and or text bundled in the Empath application, further alleviating the need for relay to a tower or other centrally located receivers or repeaters.

In this example, a security guard may be walking the halls in a building during the routine course of their patrol checks. With nothing other than an ordinary mobile device with Empath installed and on their person, the guard may create a time stamped, biometrically validated record of their presence at a particular location.

Data may be collected via an available transmission mode at the moment of contact, including but not limited to Bluetooth, Wi-Fi, cellular, and NFC. Multiple devices may act as Empath hosts regardless of their intended purpose, alleviating the need for extensive infrastructure and build outs.

The application may natively send back metadata stamped media for further examination and advice by a patrol supervisor via voice commands or screens.

A map may be created, silently and without employee input, indicating their whereabouts movement patterns throughout the course of their shift, enabling refinement or remediation of the patrol plan.

An additional benefit may be the ability to also record other contacts made during the patrol, provided other Empaths are participants. In the case of an enterprise or organization which may utilize company devices, it may be a matter of embedding the Empath application into host software on their device, which may create a tool for maintaining an insight as to the whereabouts, associations and other data related to employee movement.

In one example, six employees congregating for ten minutes each day in the vestibule of a building could indicate a group smoking break. This type of insight may alleviate the necessity for constant monitoring of CCTV footage, as it may reveal itself in visual representations of the data continuously, precisely and with baselines.

In another example, a loss of capital equipment may have occurred. By examining unusual patterns of personal interaction between previously unconnected personnel, such information might act as supporting evidence in a suspicious activity. A map may be extrapolated from the Witness database by loss prevention officers or other institutional security that may establish a means and pattern through which an incident developed.

As seeds may be passed among nodes, destruction or disabling of one or even a number of devices to avoid detection and discovery may be pointless as passive nodes may be collecting seeds, diffusing delivery, and “feeding” the database. This technology requires little human intervention.

When a suspect activity is taking place, a metadata stamped multimedia capture in the form of audio, video, photo, etc. of such event may be recorded and used as evidence if necessary. The proximity of multiple nodes may support not only that the activity occurred, but which actors were present, thus offering incontrovertible evidence.

First responders may be concerned with how to best prepare for a rapidly developing situation where the victims and/or actors may be unknown. Witness technology may facilitate locating employees for safety reasons, whether for providing medical assistance, rescue or apprehension; or while working in a subway tunnel or during an emergency, such as a fire or earthquake. During the tragic events of Sep. 11, 2001, it was difficult to determine if an individual who was supposed to be in one of the fallen buildings actually had been there.

Utilizing this technology one may be reasonably assured that not only was the person there or not, but where they were and who they were with. Such technology may have lessened the agony encountered by so many individuals who didn't know if a particular person had arrived yet, etc.

When fire, police and rescue respond to an emergent situation in a densely populated location such as an office building or office park, they may be far better served if they had an improved awareness of the employees special needs, attendance and presence at a particular place.

In addition to, or a replacement for, swiping ID cards the Empath application installed on employee phones or devices may act as a safety net (or marker) in the event that an individual needs to be located. When the employee arrives for work, they may no longer have to swipe a card, but may pass though security with the Empath application on their mobile device.

An additional form of personal, “mass deployed” security systems, may be the ability to query the user with a “challenge” sent to their device in the form of a text message, which may validate the identity of the actual employee through the use of a question, or code provided specifically to them upon arrival via their computer desktop. Such challenge may be in the form of facial recognition and/or question response (sent to them in a separate secure email) which will establish and verify their identity. If they may not be credentialed to access their email, or the face doesn't match, there may be a problem with the identity of that individual. They may have a certain amount of time to respond, determined by their role, administrator settings, etc.

Such system may also reduce the opportunity for employee impersonation and fraud, while enhancing the safety of the employee by verifying their location and identity in the event of an emergency.

Data collected may be shared with first responders as they determine the number of individuals on site, as well as their identities and special needs.

Additionally, such insight may have implications further downstream as a known identity could be used to prepare a hospital emergency room for the arrival of an individual based on their actual requirements, as opposed to an anonymous casualty, allowing medical personnel to anticipate delivery of care based on underlying conditions and known medical issues.

A profile may be created voluntarily by each employee by themselves, in the form of a “virtual medic alert bracelet” whereby first responders would have the advantage of knowing those who may be at risk when responding. (i.e., Heart patients, pregnant women, epileptics, diabetics, etc.).

When police are called upon to address incidents of employee violence, riot and Witness and Empath may be utilized to identify the location of the employees placed at risk, as well as that of a suspected perpetrator, as they may be registered with Empath much the same way as they are with legacy ID cards, Empath may act as a dynamic reporting tool to identify clusters or pockets or persons, demonstrate where and when contacts are made, and even flag individuals who have exhibited threatening or at risk behavior in the past, or who may be at risk for violence due to recent events.

In the case of the London riots in August 2011, police and public safety officials may have been able to identify clustering of individuals, indicated risk by new offenders, and revealed patterns of repeat violence by previous offenders.

Such clustering of information may reveal the numbers of involved individuals, how the groups increase in size and their movement patterns before and after an incident. Do they scatter to regroup later; are they affiliated with other groups or individuals? Such patterning awareness may help predict and perhaps prevent pending and future events, as well as point investigators to leads, ultimately helping to solve criminal cases.

This technology may track the individual, as well as track a group—a group being two or more individuals. It would be difficult to employ enough human resources to track the sheer volume of potential suspects. Additionally, Witness may offer the ability to peer into the invisible, from a virtual “umbrella” like 10,000 foot view into movements and activities of actors. It may be the equivalent to a helicopter hovering endlessly overhead, with the ability to track and identify targets even as they travel out of the scope of the helicopters sensors.

This technology may create the ground level surveillance, completely downstream, in an unobtrusive manner, utilizing the devices that the persons of interest may already have in their possession, trust and keep on or near their persons virtually twenty four hours a day.

Monitoring in a suspect area may reveal personal meetings of previously unknown actors, as well as new contact with existing actors, establishing cause to pursue such abnormal patterns.

Marketers depend on data provided by consumers via shopping patterns or active participation such as opt in, check in, web activity, etc. Offering the ability to reach non participants or “partially connected” individuals based on personal habits may be an advantage of Witness technology. The fact that a person visits a bowling alley, salon, or library, which may be made known through the contact patterns generated in Witness, may offer marketers the ability to create highly targeted personalized offers for items such as bowling accessories, cosmetics, books or any other consumer item.

Witness technology may open a previously disconnected market, reducing the need for loyalty cards and other active feedback mechanisms. Establishing that an individual participated with other individuals in a particular activity may generate data regarding frequency, time, location, etc., that may offer insights to these groups and individuals.

A “partially connected” person may have a mobile device but uses it for functions such as telephony, occasional messaging etc. They may rarely shop online and may be wary of offers that do not address their lifestyle and needs. This particular person's primary activity may be league bowling, and they may visit the same facility, and play with the same individuals weekly. Such individuals in this situation may be like minded, as they only “want to know what they want to know.”

A pattern may be established wherein these people congregate and participate in an activity that may play a significant role in their lives, which may indicate that they might be open to a marketing opportunity if it seemed “right up their alley.”

These same individuals may go out to eat at the same establishments after each bowling outing, a sports bar or family restaurant. Witness may open the marketing window by leveraging offers that these types of consumers may be comfortable with, and already express a high level of interest in by their actions. They may already be primed for offers for discount meals, sports accessories, and offers decidedly targeted to them, without their having to actively describe themselves or opt in.

The same type of consumer may visit similar establishments day in and day out, without the retailer or service provider having any insight into that person's loyalty or repeat business. Perhaps they visit the same restaurant twice a week for months and suddenly trail off. The restaurant may want the opportunity to lure the customer back without active marketing.

For example, a person visits “Bob's Taco Stand” every Thursday for lunch for four months. They may be an Empath host. Each time they visit the restaurant they may make contact with the restaurant Empath, establishing month's long patterns attendance. The restaurateur may utilize this information to create special offers for an individual based on their habits, without the need for special loyalty program and active participation (cards, devices, etc.), but they may also have the opportunity to create a retention program based on the consumer's past interest and habits.

Such programs may manifest in the form of special offers to increase use, or “we miss you” offers to lure customers back.

The Empath host may be embedded in another application, such as Open Table or Yelp, which may already in the same sphere of interest of that consumer.

Similar uses may be applied to bookstores, libraries, home improvement centers, etc, by leveraging applications specific to the interest for the individual, such as books readers, DIY software, and fan based digital magazine subscriptions such as Wine Spectator, Popular Mechanics, Sports Illustrated, Guns and Ammo, etc.).

Such application may further enhance knowledge of user habits by allowing insight into other interactions among subscribers, such as attendance at sporting events, food tasting and auto and home shows.

A further e-commerce capability may be realized from pre and post shopping activities such as dining, side trips, etc. that may not presently be identified when creating a consumer profile. Contacts and their resulting patterns with retail and commercial Empaths may reveal an ever expanding set of data about the habits of each consumer and how to address them based on their individual needs and desires in the physical world.

For example, an individual stops at the dry cleaner and pharmacy prior to visiting the supermarket each week.

By viewing such patterns, an opportunity to create additional “on the way” shopping, or convert some of those purchases to the other retailers “in the path” may be created by leveraging data from the Witness database. Movement and frequency may reveal windows of opportunity for increasing reach by offering additional, convenient consumer options.

Accident reports are largely a process of memory recall of a traumatic event, second hand reporting, and sometimes intentional misreporting based on the agenda of the parties involved. As mobile devices are ubiquitous, virtually all drivers may have one on their person while in a vehicle. As recently reported, the US government will decide whether to mandate some type of connected car technology, and dedicated radio based devices, by 2013. Many automobile manufacturers are currently exploring such systems, which may lead to fragmentation of the market in the absence of a current standard.

It could be many years before such standards may be defined and agreed upon, radio frequency spectrum assigned, and equipment manufactured. Additionally it may take decades before the current fleet of over 248 million registered cars, trucks and busses in the US may be replaced and/or retrofitted, assuming that is even practical or possible.

The common denominators as far as reporting devices in motor vehicles may be “car computers”, which only record information derived from the vehicles internal operation systems (the vehicle computer); third party vehicle systems based dedicated installed reporting devices (such as those used by insurance companies); dedicated GPS systems and their proprietary supporting systems; and the ubiquitous cell phone traveling with the driver or passengers.

The one device that may capture information, outside of the infrastructure of the vehicle itself, may be the mobile device (cell phone), which may offer insight into the activities subsequent to and post accident.

By measuring the time/location data between vehicles both moving and stationary, in addition to calculating against fixed points of reference (such as strategically located traffic devices or structures), specific patterns, paths, maps and other critical data may be utilized to establish the lead up to an event.

In a July, 2011 crash involving a bus and a truck, there was difficulty in recreating the accident due to the amount of fire and other damage. If the ability to continuously monitor benchmarks, internal to and external of the vehicles had existed, the cause and circumstances of that accident may have been more easily, rapidly and accurately revealed.

Not only did the drivers of the vehicles possess devices that could pass data, but the passengers of the other involved vehicles (as well as passers by, and mobile device equipped street lamps and structures) could have collected enough information to create a visual map if the incident indicating times and locations pre, during and post incident, where speed and other information could have been extrapolated.

The reporting may be passive in that no party has contributed anything actively other than possessing an Empath capable mobile device. Vehicles may not contain any special equipment installed or operate via any specific protocol. In some embodiments, Witness may maintain an anonymous database and descriptive reporting capability only accessible by law enforcement or other investigate bodies.

A vehicle may be traveling on an interstate highway in normal traffic when they are rear ended by another vehicle. Both drivers may have their cell phones on their persons. The driver of the front vehicle may he was driving normally. The driver of the other vehicle may claim the first driver was driving erratically and slammed on his brakes, causing the accident.

Each driver may have had an Empath enabled application installed on their cell phone.

At the time of the accident, traffic was stopped on the other side of the highway barrier, and there were street lights with cellular devices present along the roadway.

Each of the involved vehicles, the street light devices, and a number of Empath enabled vehicles traveling on the other side of the roadway may have “pinged” one another with seeds.

In the final moments prior to the event, it may be revealed that the rear vehicle had “seeded” the vehicles on the other side of the barrier more frequently than front vehicle, and that the front vehicle had acted consistently with what he reported.

Accident investigators may be able to reconstruct the accident in near real time with incontrovertible evidence from multiple reporting sources, including but not limited those involved, to establish pattern and cause.

FIG. 21 depicts an exemplary system architecture. It can be appreciated, with reference to FIG. 21, that Messaging Server controls the system, allowing clients on disparate networks to communicate. It also groups users based on network and geographic factors to allow “virtual peer groups” of partners to be formed even if they are not able to directly access each other. Data Server can store data for analysis and is separated into a private network for data protection. Client Application can be a user interface that interprets and allows for interaction with message payloads. This can either be a native application or browser based. Networks enable users to connect via a variety of networks, including public wifi, private networks, cellular, and Ad-Hoc WiFi or Bluetooth networks. Communication between partners can occur over a low-overhead UDP based protocol. Between the clients and server, an HTTP protocol can be used to allow better traversal of network boundaries.

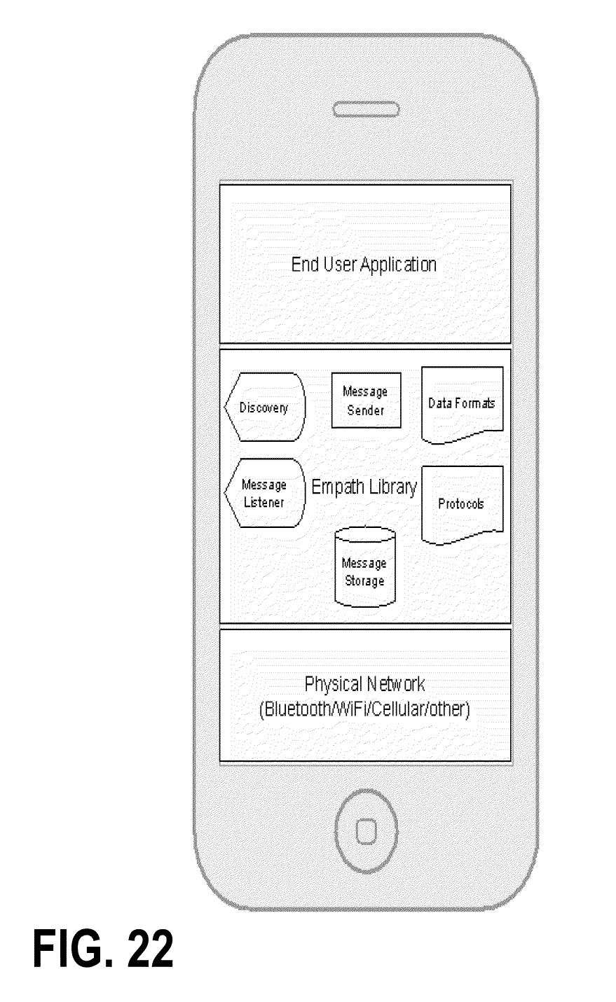

FIG. 22 depicts an exemplary native application architecture. It can be appreciated, with reference to FIG. 22, that Physical Network includes Networking systems provided by the platform, including WiFi, Ethernet, Bluetooth, and other future means such as those that support IP based networking. Empath Library is a software library that defines the components of the Empath System. Discovery is a component that uses multicast and zeroconf to discover potential partners. Message Listener receives messages sent by other partners after discovery. Message Sender sends data to partners and server based on configured rules. Data Formats—Defines how data is formatted when it is sent and stored. Protocols—Handles the details of communication between partners and servers, including security layers. Message Store stores messages and allows them to be queried/managed over time. Application can be an end user application that uses the Empath library to share data.

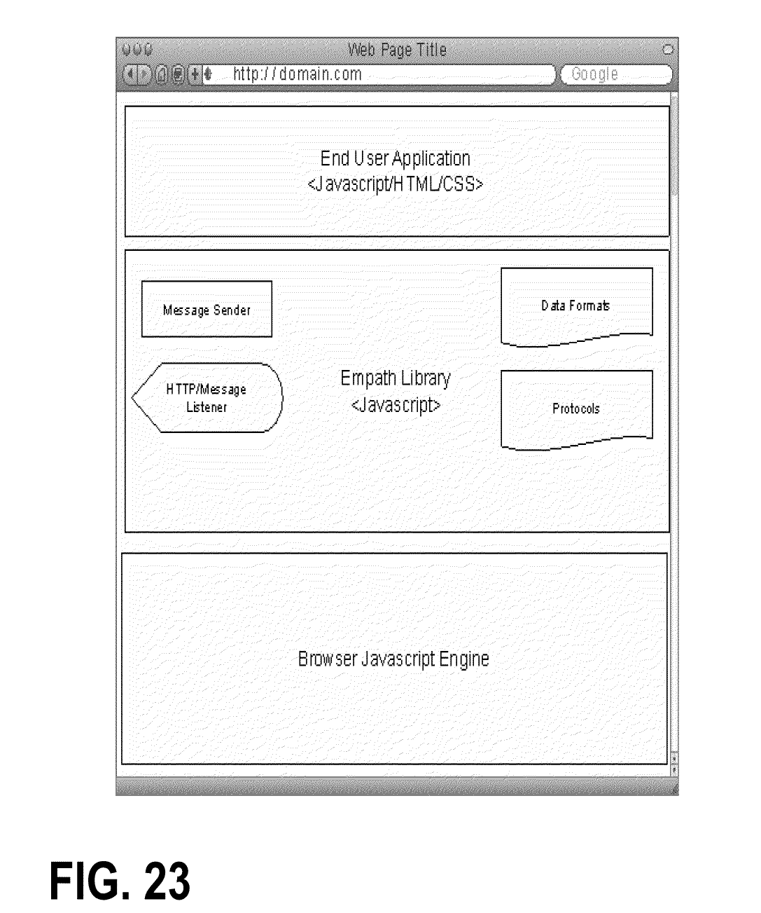

FIG. 23 depicts an exemplary browser based application architecture. It can be appreciated, with reference to FIG. 23, that Browser JavaScript Engine can be a Basic javascript system that provides network access and other capabilities. Sandboxing can be imposed to prevent cross site scripting. Empath Library (JavaScript) can include: Message Sender—Sends messages to the server as they come in, Message Listener—Sets up a persistent connection with the server to allow the server to send data to the application, Data Formats—Defines the JSON versions of the Empath data formats, and/or Protocols—Defines how the client communicates with the server, including secure communication strategies. Application can be an end-user application written in JavaScript/HTML/CSS that makes use of the Empath JavaScript Libraries.

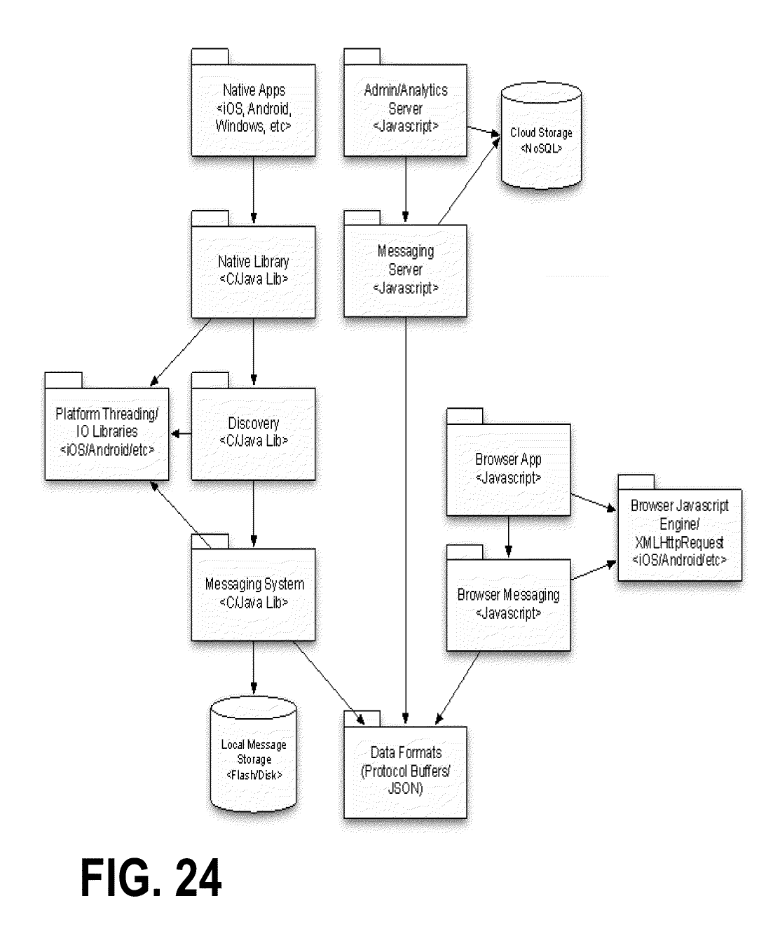

FIG. 24 depicts an exemplary module dependency view. It can be appreciated, with reference to FIG. 24, that Server −> Data Model, Application −> Framework, Framework −> Data Model, and/or Data Model.

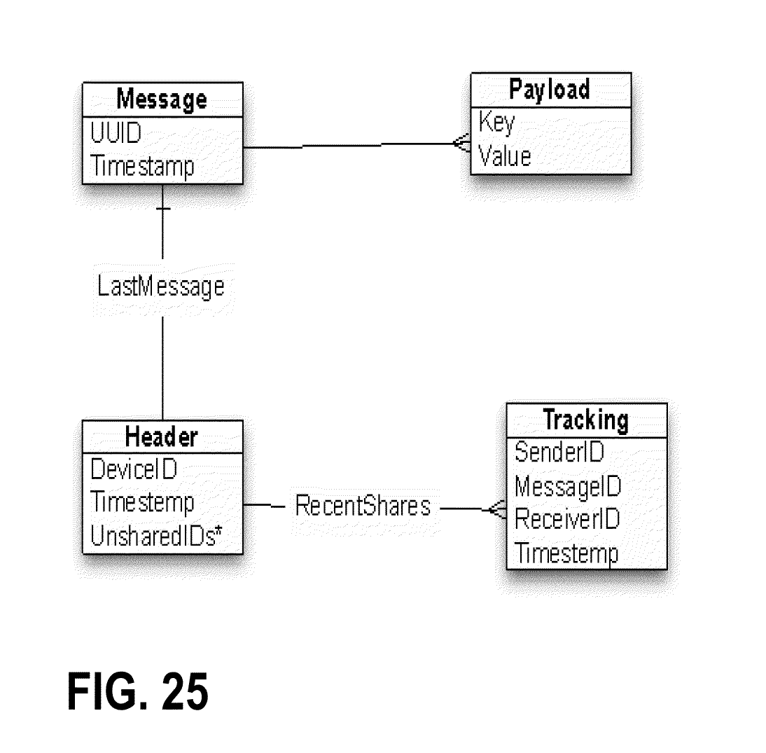

FIG. 25 depicts an exemplary high level domain. It can be appreciated, with reference to FIG. 25, that Message can include UUID of message, Creation Timestamp (UTC seconds), Message Payload, and/or (repeated) Key:Value. TrackingRecord can include UUID of sender, UUID of message, UUID of receiver, and/or Timestamp (UTC seconds). Header can include UUID of Device, Current Device Timestamp, Unshared Messages, (repeated) UUID, Most recent shares, and/or (repeated) TrackingRecord.

It should be noted with respect to the various Data Types described herein that, in certain implementations, Keys and Values are generally regarded as strings (UTF-8 character arrays), UUIDs are 128 bit numeric IDs that are randomly generated, and Timestamps are recorded as a 64 bit number representing number of seconds since Unix Epoch (Jan. 1 1970) in UTC timezone.

With respect to the various Dataflows described herein, an Application can Downloads Information from Server. On launch, the application checks timestamp for most recent message and when it was received. If share timestamp is longer then 24 hours, check with server for new messages. If new messages are available, download and store them locally, recording tracking information.

With respect to an Application Sharing Information with a Peer, in certain implementations, on launch, and periodically thereafter, the application can scan local networks (as described below with respect to integration with networks) for available partners. If a partner is found, a thread will be spawned to communicate with it. For each partner, the initiator can send a recent [or time boxed if not first request] header request that includes its current header (for 10 most recent shares/messages). The partner can respond to the header request with a header of its own and a list of requested messages (if any). The initiator can respond to the message request and include a message request of its own. The partner will supply the requested messages, and request tracking information. The initiator can respond with tracking information and a request for tracking information from partner. Partner can supply requested tracking information. Any number of steps can be repeated until all data is reconciled and/or the connection is lost.

With respect to Integration/Networking Strategy, the application can communicate, in part, over IP networks. This allows ‘piggybacking’ on existing WIFI and cellular infrastructure as well as make peer-to-peer connections over other mediums such as Bluetooth and others such as Near Field Communication (NFC) where available. By default, the application can use UDP networking for peer-to-peer communications, with consistency checks built into the communication protocol to avoid data corruption. This allows the application to avoid the overhead of establishing and maintaining a TCP connection and better match the transient nature of the communications.

With respect to WIFI, when a user is on a WIFI network, the network can be multicast pinged for empath and zeroconf hosts. All Empath respondents can be connected as partners. All zeroconf hosts can be queried for Empath registered devices and partner connection attempts can be made.

With respect to Bluetooth, on devices where it is possible, the application can periodically scan for Bluetooth devices supporting ad-hoc networking. If a piconet (Bluetooth network) already exists, an attempt can be made to join via the master. If not, a new piconet can be formed with the current device as the master.

With respect to Platform Specific Strategy, with respect to iOS, communication can occur over a WIFI transport layer, leveraging location services (always on), or spawning the application and pinging based on device movement. With respect to Android all features and transport layers can be supported.

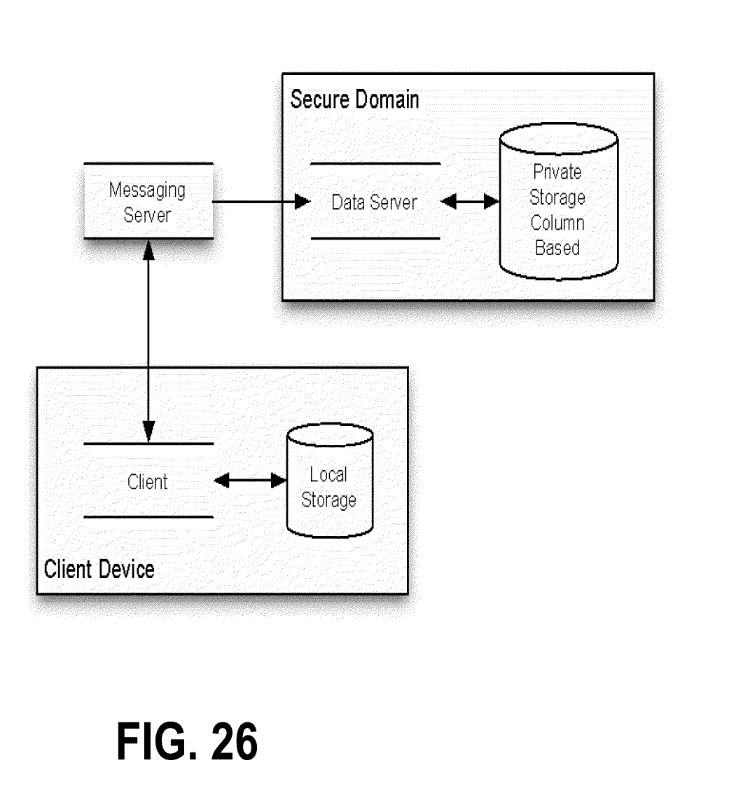

FIG. 26 depicts an exemplary data architecture strategy. It can be appreciated, with reference to FIG. 26, that Security—Authentication and Session Management can include Data Protection, including the Ability to have “private messages,” Ability to protect data on the device, Ability to de-identify user data on the server, Public/private˜symmetric keys, and/or the

Ability to protect data on the server behind several layers of security.

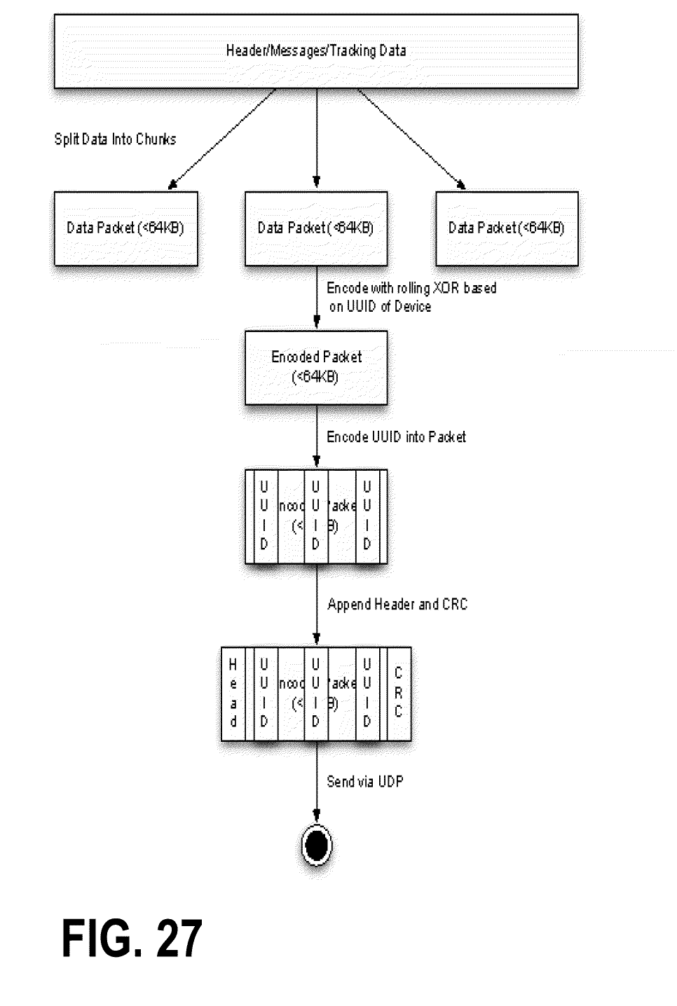

FIG. 27 depicts an exemplary wire protocol encoding.

The operation of the Empath system 700 and the various elements and components described above will be further appreciated with reference to the method for proximity-related device determination(s) as described herein.

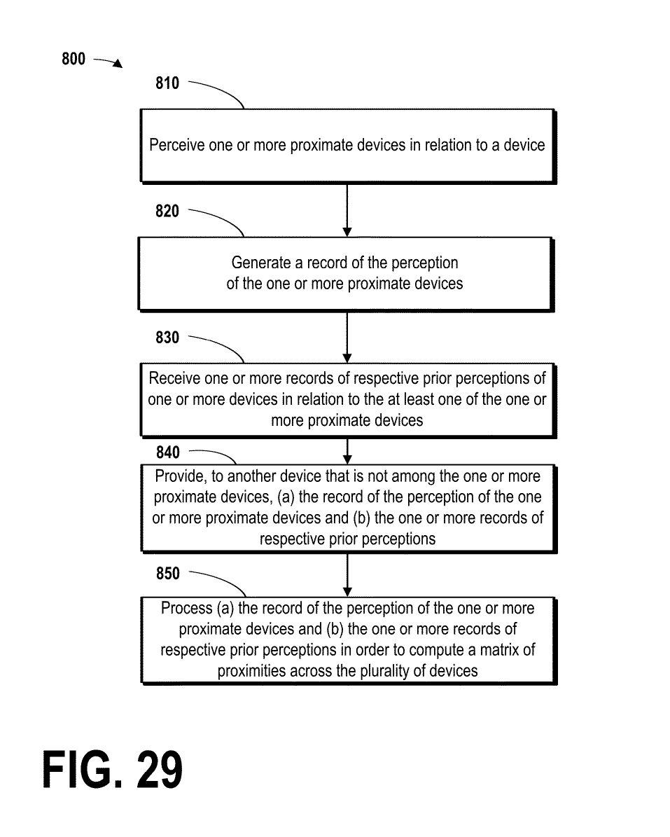

Turning now to FIG. 29, a flow diagram is described showing a routine 800 that illustrates a broad aspect of a method for proximity-related device determination(s) in accordance with at least one embodiment disclosed herein. It should be appreciated that several of the logical operations described herein are implemented (1) as a sequence of computer implemented acts or program modules running on Empath system 700 and/or (2) as interconnected machine logic circuits or circuit modules within the Empath system 700. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

At 810, processor 710 executing one or more of software modules 730, including, in certain implementations, Empath application 770, configures computing device 705 to perceive one or more proximate devices in relation to a device.

At 820, processor 710 executing one or more of software modules 730, including, in certain implementations, Empath application 770, configures computing device 705 to generate a record of the perception of the one or more proximate devices.

At 830, processor 710 executing one or more of software modules 730, including, in certain implementations, Empath application 770, configures computing device 705 to receive, from at least one of the one or more proximate devices, one or more records of respective prior perceptions of one or more devices in relation to the at least one of the one or more proximate devices.

At 840, processor 710 executing one or more of software modules 730, including, in certain implementations, Empath application 770, configures computing device 705 to provide, to another device that is not among the one or more proximate devices, (a) the record of the perception of the one or more proximate devices and (b) the one or more records of respective prior perceptions. In certain implementations, providing (a) the record of the perception of the one or more proximate devices and (b) the one or more records of respective prior perceptions can include providing, based on a determination that at least one of the one or more proximate devices are no longer perceptible to the device, (a) the record of the perception of the one or more proximate devices and (b) the one or more records of respective prior perceptions. Moreover, in certain implementations providing (a) the record of the perception of the one or more proximate devices and (b) the one or more records of respective prior perceptions can include providing, at a defined interval, (a) the record of the perception of the one or more proximate devices and (b) the one or more records of respective prior perceptions.

At 850, processor 710 executing one or more of software modules 730, including, in certain implementations, Empath application 770, configures computing device 705 to process (a) the record of the perception of the one or more proximate devices and (b) the one or more records of respective prior perceptions in order to compute a matrix of proximities across the plurality of devices.

The operation of the Empath system 700 and the various elements and components described above will be further appreciated with reference to the systems and methods for proximity-related device determination(s) and message transmission as further described herein. A complementary further aspect of the Empath system is that, through the proximity based discovery process, Empath nodes can identify devices that are in proximity thereto and can be communicated with irrespective of whether those proximate devices are Empath enabled nodes (e.g., Devices executing the Empath application or devices that are not Empath devices but are nonetheless configured to communicate wirelessly with proximate devices, say, through Bluetooth or WIFI or other RF connection protocols). Moreover, through the discovery, connection and exchange of perception records and respective perception records between Empath nodes, Empath nodes can be configured to compile cumulative records of devices (i.e., Empath nodes and non-empath devices) that form a greater network of connectivity extending beyond the physical range of a particular node.

Another complementary aspect of the Empath system described above and further described herein is that through the exchange of the cumulative records of connections between devices and the analysis of the records by Empath nodes and remote servers alike, each Empath node can be configured to compute the extent of the network in near-real time. The computation of the network can include identifying device-to-device interactions as well as paths of connectivity between the various devices within the network. In addition, the computation of the network can include determining the “strength” of the various connections between devices and the influence of individual devices within the network. As further described herein, Empath nodes can thus leverage the communication network (e.g., known device connections, connection strengths and device influence) to transmit messages to a particular target device that is physically remote (e.g., not accessible through direct communication) via one or more intervening Empath nodes. Similarly, Empath nodes are also configured to utilize the computed network to transmit messages to a target device that is not Empath enabled and is not in direct communication by transmitting messages via one or more intervening Empath devices that are capable of communicating with the target device.

In addition to the foregoing and as further described herein, the Empath system can comprise, in one embodiment, an application installed and executing on a “node” or any electronic computing device or system capable of processing instructions, storing data and transmitting and receiving data from other node devices including one or more mobile devices, server devices and the like. In addition or alternatively, the application can be a called service executing on various devices in conjunction with a remote device (e.g., server) through calls made between the devices.

The Empath systems can include an application installer (or calls on a cloud based service) that causes the application to install on the node. In some implementations, the application can be a background application, as is understood by those in the art, which is always running on the node, in the background, as a service. In this manner, the application only has to be installed once, and the application and service can remain active as long as the device is powered up, even during sleep. It can also be appreciated that if power is removed the data remains in a persistent, stored state until power is reapplied, at which time the service is automatically restarted on reboot.

The Empath application can be installed in ROM memory, as a standalone application/service or as part of an SDK hosted by another application. In some implementations, upon installation each node is assigned a unique identifier (which can only be read and understood by an authorized node or the remote server), as well as an anonymous “pairing nickname.”

Identification of other proximate devices and establishing a connection is commonly referred to as “pairing.” The application executing on respective nodes enables and controls a transmission or connectivity method (Bluetooth, NFC, WiFi Direct, P2P, broadband, etc.), which is used for passing data among nodes, circumventing the need for a communications infrastructure or backbone or a connectivity system/method shared by all devices in the network. Additionally, Empath enabled devices are configured to leverage any available connectivity to an infrastructure or backbone to communicate data to or from a remote server. Additionaly, Empath enabled devices, by being configured to switch between available connectivity systems/methods can leverage available connectivity to communicate data between devices.

Bi-directional communication between nodes, and/or nodes and server, can transmit, but is not limited to: device identifiers; metadata tags; media; payloads from any source or type; device and device state information; hardware and software configuration information; other messages; user or system generated data; hardware or software commands; instruction sets, and the like.

In some implementations, an Empath node is always “listening” for (e.g., attempting to perceive/discover) other nodes which have the platform installed and operating, and are in proximity to one another based on the operating range of the communications method (e.g. NFC=, WiFi Direct=, Bluetooth 4=). A node can communicate periodically or continuously, via any available connectivity method, preferably a method that uses the least amount of energy required. For example, via Bluetooth, the node can intermittently discover other devices that can be paired to by the node. Discovery necessarily includes receipt of a transmission broadcast by the discovered device, as would be understood by those in the art. In some implementations, a node can also perform the discovery process using multiple connectivity methods. In addition, the discovery other devices is not limited to devices having the Empath application installed and executing thereon, as other non-empath enabled devices can include software and hardware enabling discovery and pairing, as will be understood by those in the art.

Based on the discovery of other nodes, each node executing the application can be configured to create a real-time proximity based “pairing list” of proximate devices (also referred to as a perception record). Moreover, through periodically discovering proximate devices, the node can be configured to update the pairing list such that it dynamically identifies and logs other available nodes as they move in and out of range of one another in near-real time.

Proximity can be determined by the practical range of nodes to one another as defined by the communications method specification for radio frequency energy (RF), or by controlling the RF energy in each node to define a particular range from instructions in a local configuration file. The physical proximity of devices can also be determined and recorded by respective nodes by measuring RF signal strength and storing/reporting this information to provide more granular proximity measurements. In addition, a position of each device and thus relative position can be further determined based on a known location of empath devices and non-empath devices that are perceived. The known location can be determined from information automatically provided by devices (e.g., by GPS) or user input (e.g., tagging). In addition, configuration instructions concerning one or more aspects of the systems and methods described herein can be provided by the remote server.

As noted previously, communications between devices can include node to node, and node to nodes communication, as well as node to server or server to node(s) communications and a combination of the foregoing. In some implementations a node can only connect with only one other individual node. In other implementations multiple nodes can connect simultaneously, limited only by available transmission technology limitations. As noted previously, communications between proximate devices can include the exchange of messages including seed data and the like. Nodes are configured to record information concerning the exchange including a time, a location, respective device information and the like.

In some implementations, nodes can be configured to intermittently communicatively connect (referred to as “pair”) with other devices according to a defined algorithm (referred to as a “pair log” algorithm). Although establishing a communication connection between devices is referred to as “pairing,” which is a term commonly used for Bluetooth communications, the exemplary embodiments are not so limited; establishing a connection between two devices for the purposes of transmitting, receiving, or exchanging data can be performed using any available wireless communications protocols and associated hardware. Accordingly, devices can be configured to discover available devices using various available RF communication modalities so as to identify proximate devices even if they are only configured to communicate using a particular form of RF communication. The pair log algorithm can be implemented to ensure that the same nodes are not repeatedly connecting to and transmitting data between one another to the exclusion of other nodes that are in proximity to respective nodes. More specifically, a first Empath configured node can analyze the pairing list (which can be persistent as long as the devices remain in proximity) and, based on the nodes identified in the pairing list and whether communication has been previously established with those identified nodes, the algorithm can cause the first node to cycle through (i.e., connect to or “pair” with) the nodes with which it hasn't already connected to before reconnecting with a previously paired node. Accordingly, the pair-log algorithm logic can prevent two nodes from reconnecting with one another until all other nodes in respective proximities, based on the pairing list, have been communicated with.

It can be appreciated that the discovery and pairing process can be automatically performed by each node and that there is no intervention needed on the part of the node user. Accordingly, a user having the Empath application executing to define a node is not required to manually send or accept pairing requests, send data or take any other action in order to establish communications with another node or a remote server.

Once two nodes are connected (or paired), a “transaction” having a unique identifier can be created by a first node and transmitted to a second node. As noted previously, each transaction can be created to provide a precision record that two nodes communicated with one another at a specific time and at a relative location. In particular, the first node can assign the unique identifier for the transaction and send a message header, a packet and other payload data (e.g., seed data which can include enhanced or “rich” data e.g., messages, text, image, video, audio, and the like) including “session” data.

A collection of related transactions defines a “session.” Sessions are stored in respective containers including transaction and seed data exchanged between devices during the session. In accordance with the disclosed embodiments, sessions can be portable, meaning that when a node is no longer in proximity of a previously available node, it carries that data until it finds another available node and then connects to it to provide the session data. The same applies to subsets of information transferred between devices such as, payload and other data, as any data elements transmitted between paired nodes can be bound to the unique transaction identifier (“transaction ID”). Sessions or one or more portions thereof, say, payloads, can further be encrypted via a combination of public and private key encryption, depending on type and use. Accordingly, nodes can be configured to selectively un-encrypt certain data based on user access controls and node-based user permissions (e.g., using shared public/private keys) while also being a pathway/link for delivery to a further node in the network for messaging intended for a different node. In some implementations, all data can be unencrypted by the remote server.

Returning to the exemplary paring process between the first and second node in furtherance of a “transaction,” the second device can be configured to capture and store the session data transmitted by the first node in association with the transaction ID. The second node can also append the second node's own seed data (e.g., which can include one or more respective sessions or transactions between the second node and one or more other devices) to the received session data, and return the appended session to the first device. The seed data can also include respective perception records from the second device of other nodes that are or were proximate to the second device. Each completed transaction is thus a closed-loop, bi-directionally-confirmed message stored in a session container which includes the seed data from two nodes, as a single, unique transaction.

Once a transaction is complete and stored in the appended session container, each node can thereafter, based on the pairing log and the pair-log algorithm, seek out a new node with which to connect. The process is continuously repeated. It can also be appreciated that by exchanging respective session records in this particular manner a cumulative record of transactions by respective devices results. It can also be appreciated that the time and proximity based record of devices thereby provides a cumulative record of node-to-node based inter-connectivity, that can be processed to define a network topology of interconnected devices at one or more particular points in time.

In some implementations, each node can be configured to push those stored sessions as a secondary payload to every other node it communicates with, ensuring that if only a single node is able to deliver session data back to the remote server, the surviving session data will still contain a rich transaction history.

Moreover, through node-to-node distribution of payloads, data/instructions received by a node from a remote server (or another empath enabled node device) can be distributed through the network and shared with the proximate nodes. For instance, identifier strings and/or flags can be inserted into the data transferred between devices which, when received by an empath device can trigger the device to perform an action. For example, the actions triggered on a device can include selectively recording transferred data that concerns a specific target node (e.g, data associated with a particular device identifier) or set of targets nodes. Similarly, the action can also include subscribing to (i.e., requesting from other empath nodes/servers) reports about one or more target nodes. Further, patches, re-configurations, maintenance updates, etc. can be applied directly from the server or via another node by targeting using unique node identifiers. Based on an algorithm or configuration instructions, changes in a node (device) state or a manual user input can cause a node to generate a set of data instructions that is then transmitted to another node or nodes (based on unique identifier) to cause an action to occur on those secondary nodes. Similarly, the server can be configured to automatically or manually restart or reconfigure one or more nodes based on a specified set of rules.

Various processes can be implemented by the configured empath nodes to limit one or more of, the size of a session, the amount of data consumed by storage of sessions on respective nodes, or the bandwidth consumed by exchanging session data. In some implementations, a session, or group of transactions, can be limited by the virtual size of a session container (number of bytes), a number of transactions, or by a predefined period of time. For example, upon reaching that limit, the session can be designated by one or more of the nodes as closed and can no longer be appended by nodes. In some implementations, only open sessions are transmitted to other nodes, which then append respective session data, creating new and unique sessions with each successive transaction. In some implementations, only a predefined number of sessions can be stored temporarily (“archived”) on each node. In some implementations, an algorithm can be implemented to prevent duplicate sessions from being transmitted. In some implementations, a maximum number of sessions that are archived by each node can be defined, such that, if the number of archived sessions exceeds a predefined amount, the oldest session can be deleted and replaced by the newest session.

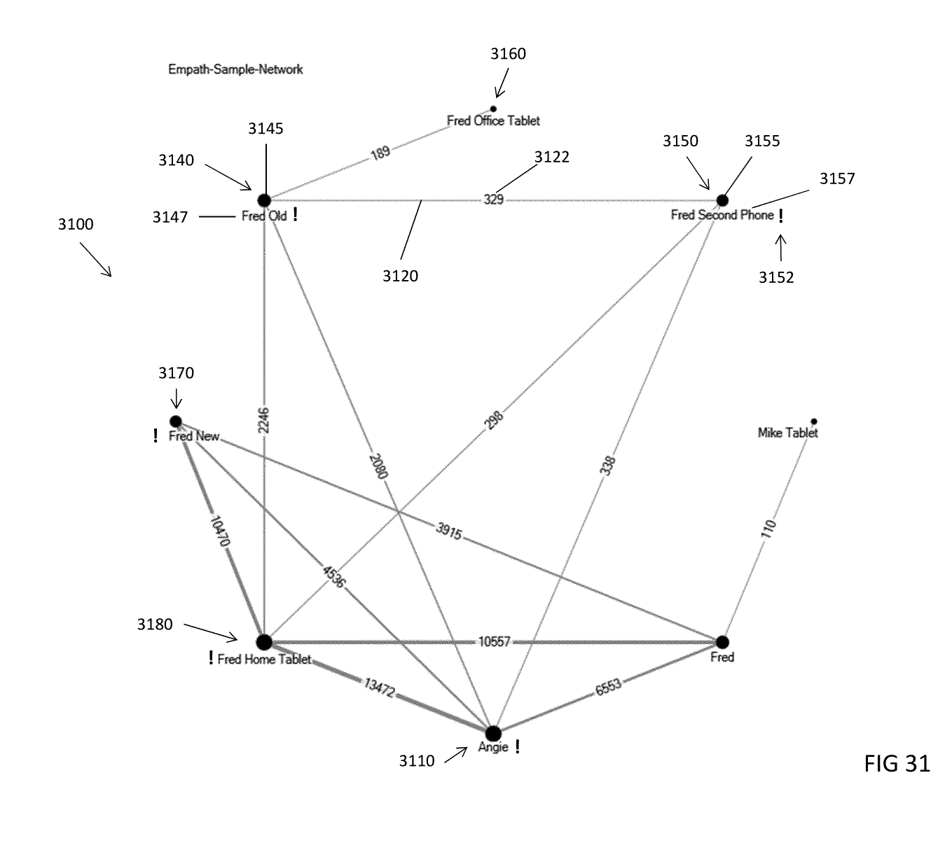

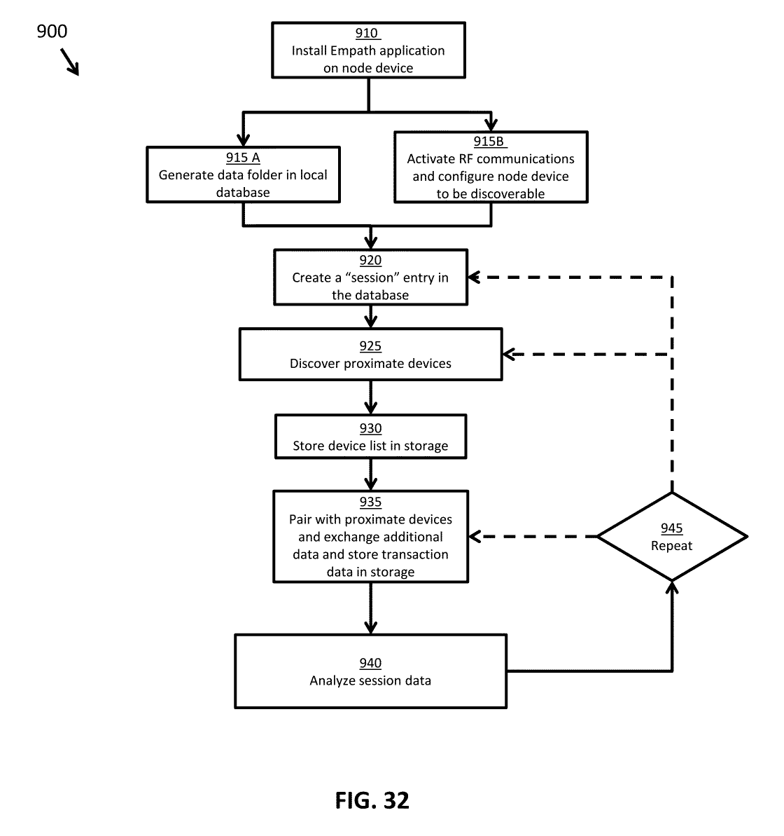

Turning now to FIG. 32, a flow diagram is described showing a routine 900 that illustrates a broad aspect of a method for proximity-related device determination(s) in accordance with at least one embodiment disclosed herein. At 910, the processor of the node device, e.g., first device/node 3110 as shown in FIG. 31, installs the empath application.

At 915A, the processor of the node device, which is configured by executing one or more software modules, including, preferably the Empath application, generates a folder containing a data and a database file in memory.

At 915B, the processor of the node device, which is configured by executing one or more software modules, including, preferably the Empath application, activates the Bluetooth (or other RF communication modality) service and makes the first node device “discoverable.”

At 920, the processor of the node device, which is configured by executing one or more software modules, including, preferably the Empath application, creates a database “session” on the local (node) device. The session consists of “transactions.” Transaction entries comprise fields for the node UID, scan time, and familiar Bluetooth names and device MAC Addresses for the devices that are party to the transaction (specifically Transaction ID; Device ID; Scan Start Time Local; Scan Start Time UTC; Scan End Time; Receiver ID; Receiver Time; Remote Mode MAC; Reported MAC Address; Created Time and the like). Additional fields can be created based on the requirements of the particular implementation.

At 925, the processor of the node device, which is configured by executing one or more software modules, including, preferably the Empath application, discovers proximate nodes and the device UID is captured from each proximate node and stored in the local folder at step 930.

In particular, when a device comes into proximity of the first node/device (based on RF range), Empath IDs and/or “Unverified” Devices IDs (e.g., devices that are discoverable but are not identified as being empath enabled devices) can be exchanged and stored to the first node's pairing (or other available RF connections) list. For instance, any Bluetooth (or other) enabled device (Verified (Empath) or Unverified (non-Empath)) may be perceived/identified/discovered during the scan and store. Unverified devices can be recorded with the “familiar” name (or “unknown” in the absence of a “familiar” name) with a respective identifier such as a MAC Address and the entry in the record can indicate that the device is not empath enabled (e.g., will not include an empath enabled “flag”).

Preferably the empath application, automatically scans (search) for other discoverable (transmitting) devices at predefined intervals (e.g., once per minute, using the device clock as a time reference). Prior to completion of the time scan interval, the pairing list containing all transmitting devices with the RF service activated is captured, and all listed names and the scan time (e.g., time-stamp based on the device clock) is stored in the database along with the local UID (MAC Address) and other data transmitted between the devices (e.g., transactions as further described at step 935). In some implementations, pairing logic (e.g., the pair log algorithm) executed by the empath node, configures the node to record and/or pair with newly appearing UIDs first, and existing UIDs last, in a rolling pattern of new to old.

At step 935, the processor of the first node, which is configured by executing one or more software modules, including, preferably the empath application, can pair with the identified devices and exchange additional data (e.g., session data) through the course of one or more transactions. The additional data associated with the transactions can be stored to the database, including but not limited to device state or any data on the node device, for inclusion as part of a unique time-stamped transaction. For instance, as described previously, once two empath enabled nodes are connected (or paired), session data can be exchanged between the nodes thereby resulting in a cumulative record of transactions performed by respective devices.

At step 940, the session data can be analyzed and reports can be generated. In some implementations, the processor of the first node, which is configured by executing one or more software modules, including, preferably the empath application, can transmit session data to a remote computing device or database server where de-duplication, normalization, association, relational modeling, analytics, integration with other databases and other data analysis functions can be performed. As described previously, the database “session” can, in some instances, be pushed to the server by a method including, but not limited to, the following: 1) as soon as a connection becomes available (the data can be sent in chunks as connectivity becomes available); 2) when the number of transactions in a session reaches a specified amount; 3) after a defined period of time; 4) if a request message is sent to the device; 5) when the session database reaches a specified size, and the like. Once uploaded, the session transactions in the local database can be deleted and a new session can be started by the first empath node. The first node can be configured to retain some data in a persistent manner on the device. For example, in a social messaging implementation, device identifiers can be stored in the local database along with records of transactions (e.g., message payloads) between those devices. In some implementations, once session data is sent to the server it can be deleted from local devices.

As noted previously, nodes can further transmit stored sessions to a remote server by secure connection or by any communications or transmission means available. Accordingly, the remote server can be configured to collect and permanently store the uniquely identified session containers, extract the contained transaction data, and can store it in one or more relational or flat file databases. A node may be configured to automatically send session data as soon as an infrastructure is detected and available, or session or any other data may lay dormant on the device until requested by the server, based on software configuration. Once pushed to the remote server, the sessions can be deleted from the node and a new session can be commenced pending communication with an available node. The sessions can be provided to the remote server according to algorithm driven delivery, remote command and/or manually initiated retrieval.

Although various exemplary embodiments are described as providing session data to the server for session reconstruction by the server, the exemplary processes for reconstructing session data described as being performed by the server should not be construed as limiting and it should be understood that each node can be configured to reconstruct all or part of the session data for near real-time monitoring of the session data and performing actions based on the reconstructed session data being monitored.

Various processes for processing session data to reconstruct a session and/or selectively extract and view transactions are described above and further described herein. In some implementations, certain payload and/or session and/or transaction data may be retained in memory on a node for later use. Each node, including the remote server, may capture, and permanently or temporarily retain, specified payload data from any single unique node, and push that data to any other unique node or group of nodes.

Session processing can also include extracting transaction data from the session containers, and deduplicating the transaction data so that only a single instance of each uniquely identified transaction is retained. Depending on the implementation, other data elements included in the session container can also be extracted and stored. For example, a time, a respective location and proximity of nodes that are party to a particular session, a particular transaction, messages or any such data contained with the payloads of the particular transaction can be extracted and stored in association with one or more transactions and one or more associated nodes.

As previously described, a collection of algorithms can be implemented by the configured nodes to examine the time and space relationships between nodes in order to, for example and without limitation, compute a network matrix as well as identify and establish individual and group patterns, predict trends, and model behaviors. Similarly, reports can be generated based on the complete and precise database record of every single time stamped transaction, or a subset thereof, and any other available supporting data. Data may be viewed as raw data, or visualized through a configurable user interface in a variety of formats including a network of interconnected devices, time-based map of devices, visual depicting of devices and patterns. Visualizations can also be supplemented with additional information concerning particular devices corresponding users and related data elements included in the corresponding session records.

For example as shown in FIG. 31, the network matrix 3100 can be depicted as a map of interconnected devices (e.g., 3140 and 3150) represented as points (e.g., 3110, 3155 and 3145) and an associated UID or a familiar name (e.g., 3147 and 3157). If a device is identified as an empath enabled node, the UID can be depicted with a flag (e.g., 3152) or other notification indicating that the device is empath enabled. In addition, the history of one or more communications between two particular nodes can be represented as an edge in the network matrix (e.g, line 3120) interconnecting two devices that have communicated.

The node that is analyzing the session data to compute the network matrix and generate the visualization (e.g., first node 3110), can also be configured to determine the “strength” of each connection between the various devices within the network. Strength can be determined as a function of the number of connections between the nodes (e.g., a number of pair events, perceptions or messages transmitted). Accordingly, the strength can be reflected in the visualization as, for instance, the actual number of connections made between two devices (e.g., 3122) or a thickness of the edge/line 3120 connecting the two devices. In addition, the influence (e.g., centrality or popularity) of each node can be determined and recorded in the network matrix. Influence of a node can be determined based on the number of connections established between that node and other nodes in the network. In addition or alternatively, influence can be determined based on the proximity between a node and all others in the network. Proximity can be a measure of physical distance or a number of edges of connectivity between a particular node to the other nodes in the network. For instance, as shown in FIG. 32, a message originating with “Fred Home Tablet” or “Angie” has the shortest number of edges linking the node to all other nodes in the network. Similarly, a node with few links to other nodes but a very strong link to a node with high influence can be identified as having substantial influence in the network. For instance, in reference to the network matrix of FIG. 32, “Fred Second Phone” can have more significant influence (i.e., centrality and/or popularity) within the network than “Mike Tablet” due to the proximity of “Fred Second Phone” to influential nodes “Fred Home Tablet” and “Angie.” Accordingly, the influence of each node can be reflected in the visualization by the size of the points depicting the nodes (e.g., 3155, 3147).

Returning to FIG. 32, at step 945, the first node device (and other empath enabled nodes) can be configured to repeat one or more of the foregoing steps at specified intervals (e.g. 1 minute), including but not limited to, pairing with devices and transmitting messages in view of the computed network matrix and/or creating a transaction record with other proximate devices. Accordingly, empath enabled devices can collect and store list data about one another with high redundancy.

It can be appreciated that, in some implementations, third party data may be non-destructively integrated with the Empath data passing protocol to support additional dimension and functionality to the messages transmitted between devices during a session. For example, the remote server may deliver notification messages, commands or other data including rich media (from a secondary or tertiary servers or other empath nodes) to a specific device UID or plurality of devices. It can also be appreciated that Empath nodes (also referred to as hosts) can be configured to introduce such additional data into the session. It can also be appreciated that empath nodes can also be configured to direct messages to specific device UIDs. Device permissions and access rules can be assigned to devices as well as the transmitted information so as to control access, availability and passing of the data based on such permissions and rules.

Session data, and portions thereof, can be delivered by a number of methods including but not limited to: 1) when a specific UID is within range; 2) on demand; 3) when a required action or set of actions takes place; 4) when a specific UID is identified within the network, irrespective of whether the identified device is in range. The specified UID or UIDs for receipt of the message may remain persistent locally until purged or purged remotely.

Through the pairing of proximate nodes and the passing of session data there-between in accordance with the disclosed embodiments, empath nodes are configured to create a self-generating unconstrained network that is continuously growing and evolving and are configured to record the continuously growing and evolving history of device-device connections (e.g., network of node-to-node communications) that can be viewed at any level, from it's entirely all the way down to the individual transaction and anywhere in between. Moreover, the scope of the network of interconnected devices can be analyzed in near real-time and used to transmit messages from one node to another particular node identified within the network.

For example, in some implementations, one or more portions of the session data (e.g., text messages within a message payload) can be addressed by the first node 3110 (e.g., or a server in communication with the first node) for delivery to a particular node. The particular node can be a node that is identified by the first node within the network matrix that is in direct communication with the first node. For instance, in the exemplary implementation of the empath application in conjunction with a social text-messaging application, upon recognition of another node's identifier by the first node, the identifier can be stored by the first node. In some implementations, the identifier can be used to establish a “side channel” communication path between the first node and the intended recipient node to pass a payload (e.g., private message) based on user permissions. This side channel communication path can be established using the same RF connection means (e.g., Bluetooth, Wifi, Cellular or other available connection means) that is being used in conjunction with the empath application or can be an alternative RF connection method. Accordingly, it can be appreciated that the side channel allows devices to select connection methods based on availability, the particular device capabilities and/or the requirements of the communication. The side channel communication can also be established using applications that are executing independently of the empath application. Moreover, a specifically addressed payload can be included in the session data that is passed between empath nodes for delivery to empath devices and non-empath devices. For example, if the first empath enabled device 3110 transmits a Bluetooth message to empath node 3140 for delivery to a remote device 3160 that is in communication with node 3140 independent of the empath application (e.g., is a non-empath device connected to node 3140 over WIFI), node 3140 can initiate a wifi based communication session with device 3160 to transmit one or more portions of the message intended for delivery to device 3160.

Communications can be transmitted directly from a first node 3110 to the intended recipient (e.g., a proximate node), or indirectly via one or more other intervening nodes within the network. For instance, if the intended recipient node is proximate to the first node, say, node 3140, the session data can be transmitted directly to the node 3140. By way of further example, if the recipient node, say, node 3160, is identified within the network but is not proximate to the first node, the session data can be transmitted to one or more proximate nodes (e.g., 3140) that are within a multi-stage node-to-node communication path between the first node and the intended recipient node. Accordingly, after receipt of the message from node 3110 and upon connecting to node 3160, node 3140 can pass one or more portions of the session data to the recipient node 3160.

In the event that node 3160 were not in direct communication with the intended recipient, node 3160 could similarly identify any intervening nodes that link node 3160 with the intended recipient node in the communication matrix and relay the message to the next node(s) in the matrix for further transmission towards the intended recipient. Accordingly, the first node 3110 can, based on the near real-time analysis of the network matrix, selectively transmit the session data to one or more proximate nodes (e.g., 3140) that are identified as being in communication with the intended recipient node (e.g., 3160) or connected to the recipient node via one or more intervening nodes. Similarly, each empath node within the matrix can perform the same real-time analysis of the network using the session data that that particular node has received from proximate nodes so as to facilitate the passing of messages on behalf of other nodes.

In some implementations, the particular intervening node(s) that the message is transmitted to can be selected by a node based on the strength of the discrete node-to-node connections between that node, any intervening node(s) and the intended recipient node. For instance, if node 3155 is instructed to transmit a message to node 3170, node 3155 can can be configured to analyze the network matrix and determine that the message can be indirectly transmitted via nodes 3110 or 3180 and that both paths include two discrete node-to-node communication steps. Node 3155 can be further configured to compare the influence of each path to determine the path of highest strength (e.g., reliability), for example, by aggregating connection strength of each discrete step in the path or averaging connection strengths or performing other comparative calculations. Accordingly, node 3155 can selectively transmit the message to node 3170 via node 3180 because the calculated strength of the path is greater than the path across node 3110. Similarly, the selection can be based on the calculated influence of the intervening nodes within the network. In addition or alternatively, the first node can broadcast the session data to one or more proximate devices, either selectively (e.g., based on connection strength or influence) or indiscriminately, for further transmission to the intended recipient nodes.

At this juncture it should be appreciated that, in accordance with the disclosed embodiments, a network of empath and non-empath devices alike can be established irrespective of whether the devices are proximate to one-another and irrespective of whether direct communication can be established between each of the devices. It can also be appreciated that, in accordance with the disclosed embodiments, a network of empath and non-empath devices can be identified and used to transmit data between empath nodes (e.g., node 3110) and non-empath devices (e.g., devices that are not in direct connection or that are not proximate, say, device 3160) via one or more intervening devices (e.g., 3140) which are configured to communicate with those remote empath and/or non-empath devices.

Moreover, the historical data of device-to-device interactions provides a record of fact wherein each transaction provides a snapshot of a moment in time and a collection of transactions provides a broader snapshot. Reports generated by the empath devices from the records, which may also be integrated with other data, can be configured to provide an interface for dynamic analysis and review of the data at varying levels of granularity and temporal scope thereby allowing a reviewer using an empath device to rewind, fast forward, zoom in/out (in temporal and spatial scope), reviewing single “snapshots” or an aggregate of data over a range or ranges of time.

It can also be appreciated that records of device to device interactions and corresponding location information collected and analyzed in accordance with the disclosed embodiments can be used to provide additional user services via empath Nodes. For instance, a detected confluence of nodes at a specified time, over a period of time, or exhibiting a pattern of contact, can trigger an action on “subscriber devices (those devices interested in a specific ID)” initiated by either on the local host or from the central server. For example and without limitation, when a party of friends arrive at a location, the action can be an alert transmitted (by one of the user devices or remote server device) that causes a drink order to be placed. By way of further example, a node passing a specific location a certain number of times during a defined time range may trigger an advertisment or marketing offer to be provided to the device.

At this juncture, it should be noted that although much of the foregoing description has been directed to systems and methods for proximity-related device determination(s), the systems and methods disclosed herein can be similarly deployed and/or implemented in scenarios, situations, and settings far beyond the illustrated scenarios. It can be readily appreciated that Empath system 700 can be effectively employed in practically any scenario where any/all of the operations described herein can be useful, including but not limited to: mining operations; underground operations; personal safety and security; nuclear reactor; intra-building operations; aviation; accident reconstruction; media and entertainment; shipping and cargo logistics and security; social networking; e-commerce and marketing; civil engineering; wildlife control; civil engineering; and traffic control. It should be further understood that any such implementation(s) and/or deployment(s) are within the scope of the systems and methods described herein.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods described herein need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for proximity-related device determination(s). The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

1. A computer-implemented method for communicating between and among a plurality of devices on a node-to-node basis and without reliance on an established network, wherein the devices include (1) a set of proximate devices comprising devices that are proximate to a first device, and (2) remote devices that are not proximate to the first device yet which include at least one device that is proximate to at least one device in the set of proximate devices, the method comprising:
perceiving, by the first device, one or more proximate devices in the set of proximate devices;
generating, by the first device, a record (“perception record” or “PR”) identifying each of the perceived proximate devices and respective first numbers of connections established between the first device and respective perceived proximate devices;
receiving, at the first device, a respective perception record generated by one or more of the one or more proximate devices, each received perception record (“RPR”) identifying any remote devices, that is, devices which are not proximate to the first device, and respective second numbers of connections established between respective proximate devices and respective remote devices;
processing, by the first device, (a) the PR and (b) one or more of the RPRs to compute a node-to-node based communication matrix among the devices, wherein the communication matrix identifies connectivity between the first device and the remote devices via at least one of the perceived proximate devices; and
transmitting, by the first device based on the computed node-to-node based communication matrix, at least one message from the first device to at least one of the remote devices across at least one of the perceived proximate devices by discrete node-to-node communications.

2. The method of claim 1, further comprising:
computing, by the first device using the respective first numbers of connections and the respective second numbers of connections, a connection strength for each of the connections in the communications matrix;
wherein the transmitting step includes transmitting the at least one message over the communication matrix in further view of the computed connection strengths.

3. The method of claim 2, further comprising:
computing, by the first device, based on the respective first numbers of connections and the respective second numbers of connections, an influence level for each of the devices in the communications matrix;
wherein the transmitting step includes transmitting the at least one message over the communication matrix in further view of the computed influence levels.

4. The method of claim 1, wherein the transmitting step comprises:
transmitting the at least one message to at least one of the remote devices indirectly via at least one of the proximate devices from which an RPR was received.

5. The method of claim 1, wherein each of the RPRs includes any respective perception records received by each respective proximate device from one or more of the remote devices.

6. The method of claim 1, wherein the PR and RPRs identify relative proximities of the identified devices and respective times of perception.

7. The method of claim 6, wherein the step of defining the node-to-node based communication matrix comprises:
computing the node-to-node based communication matrix in accordance with the relative proximities and respective times of perception identified in the PR and the one or more of the RPRs.

8. The method of claim 2, further comprising:
launching, by the first device, an application including instructions in the form of code; and
wherein the perceiving step includes:
detecting, by the first device, the one or more proximate devices in the set of proximate devices that are executing respective instances of the application (“empath devices”) and any other proximate devices in the set of proximate devices that are in communication with the first device independent of the application (“non-empath devices”);
storing, by the first device in the PR, information identifying the one or more perceived empath devices and any of the perceived non-empath devices; and
wherein each RPR identifies the one or more remote devices as remote empath devices or remote non-empath devices.

9. The method of claim 8, wherein the transmitting step includes transmitting the at least one message over the communication matrix in further view of the identification of the one or more proximate devices and the one or more remote devices that are executing respective instances of the application.

10. The method of claim 3, further comprising:
generating, by the first device, the at least one message, wherein the at least one message includes one or more of the following:
the PR;
one or more of the RPRs;
an identifier identifying the first device;
a second identifier identifying a recipient device;
a message creation timestamp; and
one or more stored messages.

11. The method of claim 10, further comprising:
identifying, by the first device using the node-to-node based communication matrix, a particular remote device; and
wherein the step of generating the at least one message includes addressing at least a portion of the one or more messages for delivery to the particular remote device.

12. The method of claim 11, further comprising:
identifying, by the first device using the node-to-node based communication matrix, at least one proximate device among the one or more perceived proximate devices that is in direct communication with the particular remote device or is in indirect communication with the particular remote device via one or more other devices in the communication matrix; and
wherein the step of transmitting at least one message from the first device to the remote device includes transmitting the at least one message to the at least one proximate device.

13. The method of claim 12, wherein the at least one proximate devices are identified according to the respective influence levels for the devices in the communications matrix and the respective computed connection strengths.

14. The method of claim 13, wherein the message is configured to cause the at least one proximate devices to transmit the at least one message directly to the particular remote device or indirectly via one or more other devices in the communication matrix by discrete node-to-node communications.

15. (canceled)

16. (canceled)

17. (canceled)

18. (canceled)

19. A computer-implemented method for communicating between and among a plurality of devices on a node-to-node basis and without reliance on an established network, wherein the devices include (1) a set of proximate devices comprising devices that are proximate to a first device, and (2) remote devices that are not proximate to the first device yet which include at least one device that is proximate to at least one device in the set of proximate devices, the method comprising:
launching, by the first device, an application including instructions in the form of code;
perceiving, by the first device, one or more proximate devices among the set of proximate devices that are executing respective instances of the application (“empath devices”) and any other proximate devices in the set of proximate devices that are in communication with the first device independent of the application (“non-empath devices”);
generating, by the first device, a record (“perception record” or “PR”) identifying the one or more perceived empath devices and any of the perceived non-empath devices;
receiving, at the first device, a perception record from respective proximate empath devices, each received perception record (“RPR”) identifying one or more remote devices which are not proximate to the first device yet which are proximate to respective empath devices and indicating whether the one or more remote devices are remote empath devices or remote non-empath devices;
processing, by the first device, the PR and one or more of the RPRs, to compute in near-real time a node-to-node based communication matrix among the devices, wherein the communication matrix identifies discrete paths of connectivity between the first device and the one or more remote devices via at least one of the proximate empath devices and provides a classification for each of the devices in the communication matrix, wherein the classification includes one or more of: an empath device or a non-empath device; and
transmitting, by the first device based on the communication matrix, at least one message from the first device to at least one of the remote devices across at least one of the perceived proximate empath devices by discrete node-to-node communications.

20. The method of claim 21, further comprising:
determining, by the first device, respective first numbers of connections established between the first device and the one or more proximate devices, respectively; recording, by the first device in the PR, the respective first number of connections, and wherein each RPR includes respective second numbers of connections established between respective proximate devices and respective remote devices;
computing, by the first device using the respective first numbers of connections and the respective second numbers of connections, a connection strength for each of the connections in the communications matrix;
wherein the transmitting step includes transmitting the at least one message over the communication matrix in further view of the computed connection strengths.

21. The method of claim 20, further comprising:
computing, by the first device, based on the respective first numbers of connections and the respective second numbers of connections, an influence level for each of the devices in the communications matrix;
wherein the transmitting step includes transmitting the at least one message over the communication matrix in further view of the computed influence levels.

22. The method of claim 21, further comprising:
identifying, by the first device using the communication matrix, a particular remote device among the one or more remote devices,
identifying, by the first device using the communication matrix, at least one proximate empath device that is in direct communication with the remote device independent of the application, or in indirect communication with the remote non-empath device via one or more intervening devices; and
transmitting, by the first device, the at least one message to the remote non-empath device indirectly via the at least one proximate empath device.

23. The method of claim 22, wherein the at least one proximate devices are identified according to the numbers of connections established between the first device and respective perceived proximate devices and the numbers of connections established between respective proximate devices and respective remote devices.

24. The method of claim 23, further comprising:
generating, by the first device, the at least one message, wherein the at least one message includes one or more of the following:
the PR;
one or more of the RPRs;
an identifier identifying the first device;
a second identifier identifying a recipient device;
a message creation timestamp; and
one or more stored messages.

25. (canceled)

26. (canceled)

27. (canceled)

28. (canceled)

29. A system comprising:
a computer-readable storage medium storing software modules including instructions in the form of code;
a processor configured by executing the software modules therein to perform operations comprising:
perceive, by the processor, one or more proximate devices in the set of proximate devices;
generate, by the processor, a record (“perception record” or “PR”) identifying each of the perceived proximate devices and numbers of connections established between the processor and respective perceived proximate devices;
receive, at the processor, a perception record generated by each perceived proximate device that is executing the application, each received perception record (“RPR”) identifying any remote devices, that is, devices which are not proximate to the processor, and numbers of connections established between respective proximate devices and respective remote devices;
process, by the processor, (a) the PR and (b) one or more of the RPRs to compute a node-to-node based communication matrix among the devices, wherein the communication matrix identifies connectivity between the processor and the remote devices via at least one of the perceived proximate devices; and
transmit, by the processor based on the computed node-to-node based communication matrix, at least one message from the processor to at least one of the remote devices across at least one of the perceived proximate devices by discrete node-to-node communications.
